(19) United States
(12) Patent Application Publication
(10) Pub. No.: US 2023/0349553 A1
(43) Pub. Date: Nov. 2, 2023

(54) SYSTEMS AND METHODS FOR ANALYZING COMBUSTION SYSTEM OPERATION

(71) Applicant: Onpoint Technologies, LLC, Wichita, KS (US)

(72) Inventors: Chad CARROLL, Tulsa, OK (US); Junda ZHU, Tulsa, OK (US)

(21) Appl. No.: 18/023,391

(22) PCT Filed: Sep. 7, 2021
(86) PCT No.: PCT/IB2021/058144

§ 371 Date: Feb. 27, 2023

Related U.S. Application Data
(60) Provisional application No. 63/076,412, filed on Sep. 10, 2020.

(51) Int. Cl. F23N 5/26

(52) U.S. Cl. CPC F23N 5/265; F23N 2223/04

(57) ABSTRACT

Systems and methods analyze combustion system operation by predicting an operating parameter based on a portion of measured process data. The predicted operating parameter is associated with a prediction confidence region that is based on hardware uncertainty and historical uncertainty. The historical uncertainty defines drift of the variables used to predict the operating parameter as compared to historical distribution of the values of the variables. The combustion system operation may also be analyzed by comparing a predicted operating parameter against a measured operating parameter, and using the comparison to match to an anomaly solutions database.

### RELATED APPLICATIONS

This application claims priority U.S. Provisional Patent Application No. 63/076,412, filed Sep. 10, 2020, which is incorporated herein by reference in its entirety.

### BACKGROUND

Combustion systems operate by converting fuel and air into thermal energy within a process heater. Downstream from this conversion location, various sensors operate to collect emissions and flue gas composition data such as Nitrous Oxide (NO_{X}), Oxygen (O₂), and Carbon Monoxide (CO). Many parameters are sensed by various sensors throughout the combustion system. Oxygen measurements, in particular, are indicative of the amount of air input into the system that is in excess of the required amount of air needed for the conversion of the fuel to thermal energy (stoichiometric air requirements). These oxygen measurements are used to control the input and ratio of fuel and air into the system. If these oxygen measurements are not correct, such as due to unwanted excess air entering the system at leaks in the system housing (sometimes referred to as tramp air), or extra fuel entering the system (via holes in the process tubes of the combustion system), or insufficient air being provided to the system (via malfunctioning or blocked air inlets at the burners), the control of the heater becomes inefficient and potentially unsafe.

Process heaters have multiple burners (sometimes up to 200+ burners per furnace) and each one has one or multiple burner tips, each configured to inject fuel according to a specific flow rate/pattern for combustion within the heater. Over time, these burner tips become clogged or begin to foul with “coke” and other material. This clogging (also known as plugging) causes the collective burner system to operate inefficiently. Additionally, plugged gas tips can cause an otherwise stable burner to lose its flame anchoring or relighting capability, causing substantial safety concerns if not maintained frequently or properly. There exists a need to identify anomalies in the operation of the combustion system in an accurate, safe, and thorough manner utilizing existing hardware components without requiring significant overhead to retrofit existing combustion systems, or incorporate expensive additional hardware during design of new-build combustion systems.

### BRIEF DESCRIPTION OF THE FIGURES

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 depicts an example system of a process heater with automatic air register setting determination, in embodiments.

FIG. 2 depicts a typical draft profile throughout a heater (e.g., the heater of FIG. 1).

FIG. 3 depicts a plurality of example process tube types.

FIG. 4 depicts a diagram showing air temperature and humidity effects on sensed excess O₂ levels.

FIG. 5 depicts a schematic of air and fuel mixture in a pre-mix burner, in embodiments.

FIG. 6 depicts a schematic of air and fuel mixture in a diffusion burner, in embodiments.

FIG. 7 depicts an example cutaway diagram of a burner, which is an example of the burner of FIG. 1.

FIG. 8 depicts an example air register handle and indicator plate 804 that is manually controlled.

FIG. 9 depicts example burner tips with different shapes and sizes.

FIG. 10 depicts example burner tips with the same shape, but different drill hole configurations.

FIG. 11 depicts a block diagram of the process controller of FIG. 1 in further detail, in embodiments.

FIGS. 12-16 depict various operating conditions result in sensed oxygen readings by the oxygen sensor of FIG. 1 that cause incorrect control of the input fuel/air ratio to the burner of FIG. 1, in examples.

FIG. 17 depicts a combustion system analyzer for use in identifying anomalies within a combustion system, in an embodiment.

FIG. 18 shows the impact of using a GMM to establish the historical uncertainty of FIG. 17 in association with the prediction confidence score.

FIG. 19 depicts an example time-series graph of a predicted operating parameter, and the associated prediction confidence region of FIG. 17, in an embodiment.

FIG. 20 depicts a method for controlling a combustion system based on a prediction confidence region, in an embodiment.

FIG. 21 depicts a method for providing intelligent control of a combustion system, in an embodiment.

### DETAILED DESCRIPTION OF THE EMBODIMENTS

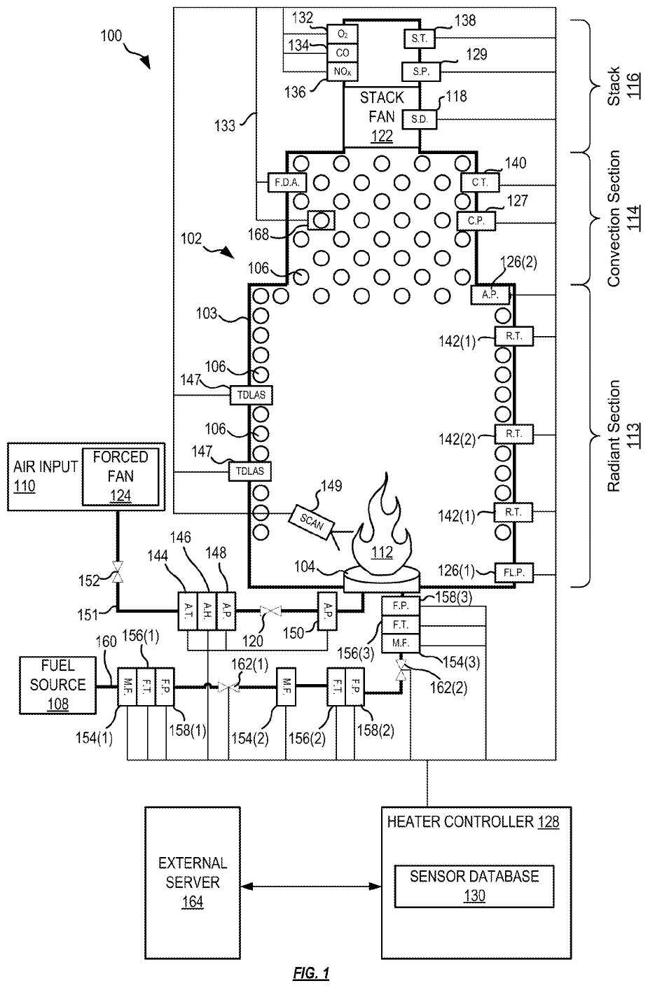

FIG. 1 depicts an example system 100 of a process heater with intelligent monitoring system, in embodiments. The system 100 includes a heater 102 that is heated by one or more burners 104 located in the housing 103 thereof. Heater 102 can have any number of burners 104 therein, each operating under different operating conditions (as discussed in further detail below). Moreover, although FIG. 1 shows a burner located on the floor of the heater 102, one or more burners may also be located on the walls and/or ceiling of the heater 102 without departing from the scope hereof (indeed, heaters in the industry often have over 100 burners). Further, the heater 102 may have different configurations, for example a box heater, a cylindrical heater, a cabin heater, and other shapes, sizes, etc. as known in the art.

Burner 104 provides heat necessary to perform chemical reactions or heat up process fluid in one or more process tubes 106 (not all of which are labeled in FIG. 1. Any number of process tubes 106 may be located within the heater 102, and in any configuration (e.g., horizontal, vertical, curved, off-set, slanted, or any configuration thereof). Burner 104 is configured to combust a fuel source 108 with an oxidizer such as air input 110 to convert the chemical energy in the fuel into thermal energy 112 (e.g., a flame). This thermal energy 112 then radiates to the process tubes 106 and is transferred through the process tubes 106 into a material therein that is being processed. Accordingly, the heater 102 typically has a radiant section 113, a convection section 114, and a stack 116. Heat transfer from the thermal energy 112 to the process tubes 106 primarily occurs in the radiant section 113 and the convection section 114.

Airflow into the heater 102 (through the burner 104) typically occurs in one of four ways natural, induced, forced, and balanced.

A natural induced airflow draft occurs via a difference in density of the flue gas inside the heater 102 caused by the combustion. There are no fans associated in a natural induced system. However, the stack 116 includes a stack damper 118 and the burner includes a burner air register 120 that are adjustable to change the amount of naturally induced airflow draft within the heater 102.

An induced airflow draft system includes a stack fan (or blower) 122 located in the stack (or connected to the stack) 116. In other or additional embodiments, other motive forces than a fan are be used to create the induced draft, such as steam injection to educts flue gas flow through the heater. The stack fan 122 operates to pull air through the burner air register 120 creating the induced-draft airflow within the heater 102. The stack fan 122 operating parameters (such as the stack fan 122 speed and the stack damper 118 settings) and the burner air register 120 impact the draft airflow. The stack damper 118 may be a component of the stack fan 122, or separate therefrom.

A forced-draft system includes an air input forced fan 124 that forces air input 110 into the heater 102 via the burner 104. The forced fan 124 operating parameters (such as the forced fan 124 speed and the burner air register 120 settings) and the stack damper 118 impact the draft airflow. The burner air register 120 may be a component of the forced fan 124, but is commonly separate therefrom and a component of the burner 104.

A balanced-draft system includes both the air input forced fan 124 and the stack fan 122. Each fan 122, 124 operate in concert, along with the burner air register 120 and stack damper 118 to control the airflow and draft throughout the heater 102.

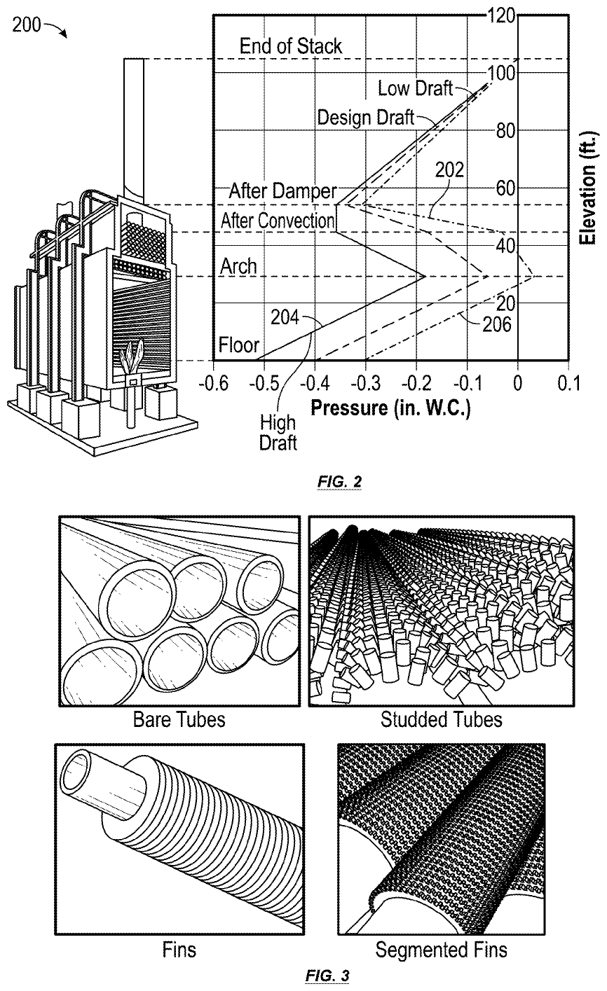

Draft throughout the heater 102 varies depending on the location within the heater 102. FIG. 2 depicts a typical draft profile 200 throughout a heater (e.g., heater 102). Line 202 depicts a desired draft that is consistent with the design of the heater and components therein. Line 204 depicts a high draft situation where pressure in the heater is more negative than desired (and thus further negative compared to atmospheric pressure outside of the heater). Line 206 depicts a low draft situation where pressure in the heater is more positive than desired (and thus closer to or greater than atmospheric pressure outside of the heater). As shown, by line 202, heaters are often designed to have a −0.1 pressure at the arch of the heater.

Draft throughout the heater 102 is also be impacted based on the geometry of the heater and components thereon. For example, draft is strongly a function of heater 102 height. The taller the heater 102, the more negative the draft will be at the floor of the heater 102 to maintain the same draft level at the top of the heater 102 (normally −0.1 in H₂O). The components greatly impact the draft. For example, FIG. 3 depicts a plurality of process tube types. The convection section process tubes 106 may or may not have heat sink fins thereon to manage the heat transfer from the thermal energy 112 to the process tube 106. These convection section fins may plug or corrode overtime-varying the required draft within a heater as compared to the designed draft for the same heater with the same components. As the convection section flue gas channel open area begins to decrease, a greater pressure differential is required to pull the same quantity of flue gas through the convection section.

Referring to FIG. 1, pressure (indicating draft) within the heater 102 is measured at a variety of locations in the heater respectively via one of a plurality of pressure sensors. Floor pressure sensor 126(1) measures the pressure at the floor of the heater 102. Arch pressure sensor 126(2) measures the pressure at the arch of the heater 102 where the radiant section 113 transitions to the convection section 114. Convection pressure sensor 127 measures the pressure of the convection section 114. Stack pressure sensor 129, if included, measures the pressure of the stack 116.

The pressure sensors 126, 127, 129 may include a manometer, or a Magnehelic draft gauge, where the pressure readings are manually entered into process controller 128 (or a handheld computer and then transferred wirelessly or via wired connection from the handheld computer to the process controller 128) including a sensor database 130 therein storing data from various components associated with the heater 102. The pressure sensors 126, 127, 129 may also include electronic pressure sensors and/or draft transmitters that transmit the sensed pressure to the process controller 128 via a wired or wireless connection 133. The wireless or wired connection 133 may be any communication protocol, including WiFi, cellular, CAN bus, etc.

The process controller 128 is a distributed control system (DCS) (or plant control system (PLC) used to control various systems throughout the system 100, including fuel-side control (e.g., control of components associated with getting fuel source 108 into the heater 102 for combustion therein), air-side control (e.g., control of components associated with getting air source 110 into the heater 102), internal combustion-process control (e.g., components associated with managing production of the thermal energy 112, such as draft within the heater 102), and post-combustion control (e.g., components associated with managing the emissions after production of the thermal energy 112 through the stack 116). The process controller 128 typically includes many control loops, in which autonomous controllers are distributed throughout the system 100 (associated with individual or multiple components thereof), and including a central operator supervisory control.

Operating conditions within the heater 102 (such as draft, and the stoichiometry associated with creating the thermal energy 112) are further impacted via atmospheric conditions, such as wind, wind direction, humidity, ambient air temperature, sea level, etc. FIG. 4 depicts a diagram 400 showing air temperature and humidity effects on sensed excess O₂ levels. The changes in operating conditions are often controlled by monitoring and manipulating the draft conditions within the heater 102. The stack dampers 118 are commonly digitally controlled, and therefore often controllable from the operating room of the system 100, via the process controller 128. However, many systems do not include burner air registers 120 that are digitally controlled. Because of this, system operators often control draft within the heater 102 using just an electronic stack damper (e.g., stack damper 118) thereby avoiding timely and costly manual operation of each burner air register (e.g., burner air register 120) associated with each individual burner (e.g., burner 104). This cost grows depending on the number of burners located in each heater—each heater may have over 100 burners therein.

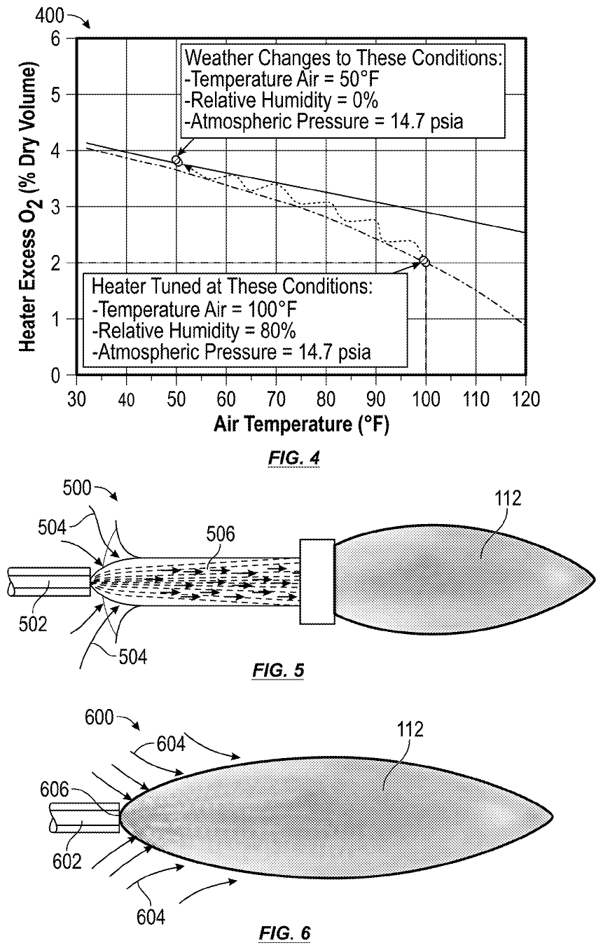

In addition to the draft as discussed above, burner geometry plays a critical role in managing the thermal energy 112 produced in the heater 102. Each burner 104 is configured to mix the fuel source 108 with the air source 110 to cause combustion and thereby create the thermal energy 112. Common burner types include pre-mix burners and diffusion burners. FIG. 5 depicts a schematic 500 of air and fuel mixture in a pre-mix burner, in embodiments. In a pre-mix burner, kinetic energy of the fuel gas 502 draws some primary air 504 needed for combustion into the burner. The fuel and air mix to create an air/fuel mixture 504 having a specific air-to-fuel ratio prior to igniting to create the thermal energy 112. FIG. 6 depicts a schematic 600 of air and fuel mixture in a diffusion burner, in embodiments. In a diffusion burner, air 604 for combustion is drawn (by induced- or natural-draft) or pushed (by forced-, or balanced-draft) into the heater before mixing with the fuel 602. The mixture burns at the burner gas tip 606.

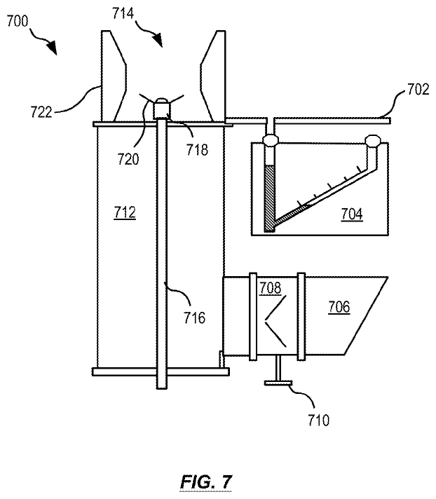

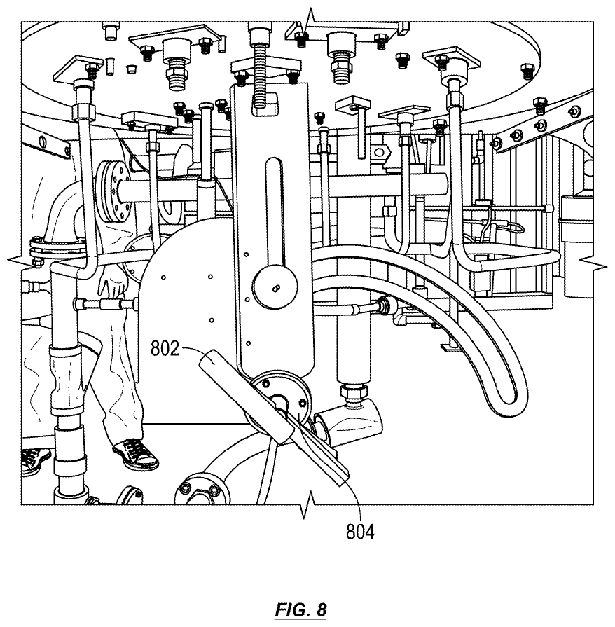

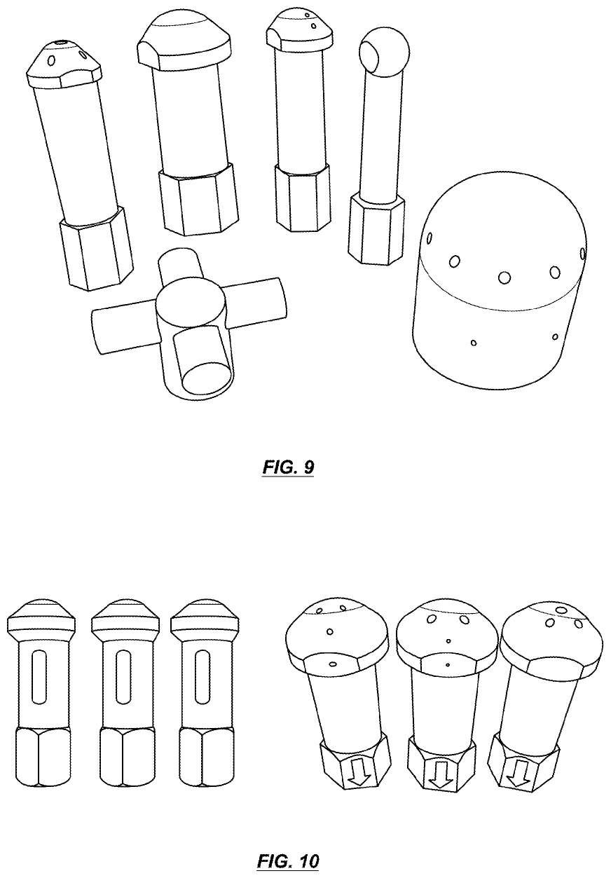

FIG. 7 depicts an example cutaway diagram of a burner 700, which is an example of the burner 104 of FIG. 1. Burner 700 is an example of a diffusion burner. Burner 700 is shown located mounted in a heater at the heater floor 702. Proximate the burner 700 in the heater floor 702 is a manometer 704, which is an example of the pressure sensors 126, 127, 129 discussed above. The manometer 704 may be another type of pressure sensor without departing from the scope hereof. Burner 700 is shown for a natural or induced-draft heater system, and includes a muffler 706 and a burner air register 708. Ambient air flows through the muffler 706 from outside the heater system. In a forced or balanced-draft system, the muffler 706 may not be included and instead be replaced with an intake ducting from the forced fan (e.g., forced fan 124 in FIG. 1). The burner air register 708 is an example of the burner air register 120 discussed above with respect to FIG. 1, and may be manipulated via an air register handle 710 to one of a plurality of settings defining how open or closed the air register 708 is. As discussed above, the air register handle 710 is typically manually controlled (although sometimes is fitted with an actuator, or provided with mechanical linkage and an actuator so a single actuator manipulates a plurality of burners). FIG. 8 depicts an example air register handle 802 and indicator plate 804 that is manually controlled. The input air then travels through the burner plenum 712 towards the burner output 714 where it is mixed with input fuel and ignited to combust and produce thermal energy (e.g., thermal energy 112 of FIG. 1).

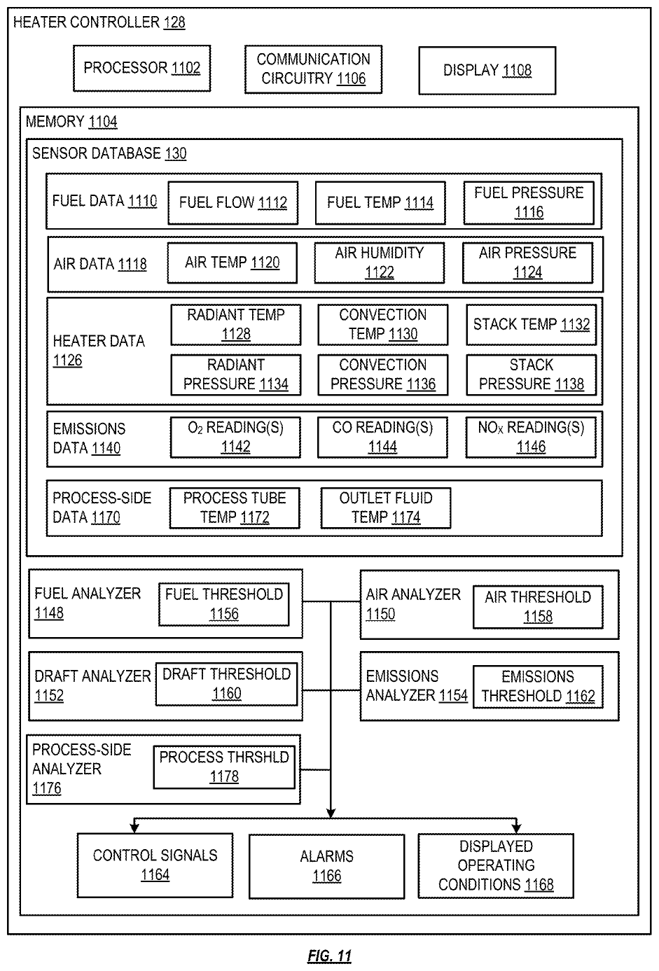

The fuel travels through a fuel line 716, and is output at a burner tip 718. The fuel may be disbursed on a deflector 720. The burner tip 718 and deflector 720 may be configured with a variety of shapes, sizes, fuel injection holes, etc. to achieve the desired combustion results (e.g., flame shaping, emissions tuning, etc.). FIG. 9 depicts example burner tips with different shapes and sizes. FIG. 10 depicts example burner tips with the same shape, but different drill hole configurations. Furthermore, one or more tiles 722 may be included at the burner output 714 to achieve a desired flame shape or other characteristic.

Referring to FIG. 1, control of the system 100 occurs both manually and digitally. As discussed above, various components, such as burner air register 120 are commonly manually controlled. However, the system 100 also includes a variety of sensors throughout the heater 102, the fuel-side input, and the air-side input used to monitor and control the system using the process controller 128.

At the stack 116, an oxygen sensor 132, a carbon monoxide sensor 134, and NOₓ sensor 136 can be utilized to monitor the condition of the exhaust and emissions leaving the heater 102 via the stack 116. Each of the oxygen sensor 132, carbon monoxide sensor 134, and NO_{X} sensor 136 may be separate sensors, or part of a single gas-analysis system. The oxygen sensor 132, carbon monoxide sensor 134, and NOₓ sensor 136 are each operatively coupled to the process controller 128 via a wired or wireless communication link. These sensors indicate the state of combustion in the heater 102 in substantially real-time. Data captured by these sensors is transmitted to the process controller 128 and stored in the sensor database 130. By monitoring the combustion process represented by at least one of the oxygen sensor 132, carbon monoxide sensor 134, and NOₓ sensor 136, the system operator may adjust the process and combustion to stabilize the heater 102, improve efficiency, and/or reduce emissions. In some examples, other sensors, not shown, can be included to monitor other emissions (e.g., combustibles, methane, sulfur dioxide, particulates, carbon dioxide, etc.) on a real-time basis to comply with environmental regulations and/or add constraints to the operation of the process system. Further, although the oxygen sensor 132, carbon monoxide sensor 134, and NOₓ sensor 136 are shown in the stack 116, there may be additional oxygen sensor(s), carbon monoxide sensor(s), and NOₓ sensor(s) located elsewhere in the heater 102, such as at one or more of the convection section 114, radiant section 113, and/or arch of the heater 102. The above discussed sensors in the stack section may include a flue gas analyzer (not shown) prior to transmission to the process controller 128 that extract, or otherwise test, a sample of the emitted gas within the stack 116 (or other section of the heater) and perform an analysis on the sample to determine the associated oxygen, carbon monoxide, or NOₓ levels in the sample (or other analyzed gas). Other types of sensors include tunable laser diode absorption spectroscopy (TDLAS) systems that determine the chemical composition of the gas based on laser spectroscopy.

Flue gas temperature may also be monitored by the process controller 128. To monitor the flue gas temperatures, the heater 102 may include one or more of a stack temperature sensor 138, a convection sensor temperature sensor 140, and a radiant temperature sensor 142 that are operatively coupled to the process controller 128. Data from the temperature sensors 138, 140, 142 are transmitted to the process controller 128 and stored in the sensor database 130. Further, each section may have a plurality of temperature sensors—in the example of FIG. 1, there are three radiant section temperature sensors 142(1)-(3). The above discussed temperature sensors may include a thermocouple, suction pyrometer, and/or laser spectroscopy analysis systems that determine the temperature associated with the given temperature sensor.

The process controller 128 may further monitor air-side measurements and control airflow into the burner 104 and heater 102. Air-side measurement devices include an air temperature sensor 144, an air-humidity sensor 146, a pre-burner air register air pressure sensor 148, and a post-burner air register air pressure sensor 150. In embodiments, the post-burner air pressure is determined based on monitoring excess oxygen readings in the heater 102. The air-side measurement devices are coupled within or to the air-side ductwork 151 to measure characteristics of the air flowing into the burner 104 and heater 102. The air-temperature sensor 144 may be configured to sense ambient air temperatures, particularly for natural and induced-draft systems. The air-temperature sensor 144 may also be configured to detect air temperature just prior to entering the burner 104 such that any pre-heated air from an air-preheat system is taken into consideration by the process controller 128. The air-temperature sensor 144 may be a thermocouple, suction pyrometer, or any other temperature measuring device known in the art. The air humidity sensor 146 may be a component of the air temperature sensor, or may be separate therefrom, and is configured to sense the humidity in the air entering the burner 104. The air temperature sensor 144 and air humidity sensor 146 may be located upstream or downstream from the burner air register 120 without departing from the scope hereof. The pre-burner air register air pressure sensor 148 is configured to determine the air pressure before the burner air register 120. The post-burner air register air pressure sensor 150 is configured to determine the air pressure after the burner air register 120. The post-burner air register air pressure sensor 150 may not be a sensor measuring the furnace draft at the burner elevation, or other elevation and then calculated to determine the furnace draft at the burner elevation. Comparisons between the post-burner air register air pressure sensor 150 and the pre-burner air register air pressure sensor 148 may be made by the process controller to determine the pressure drop across the burner 104, particularly in a forced-draft or balanced-draft system. Air-side and temperature measurements discussed herein may further be measured using one or more TDLAS devices 147 located within the heater 102 (at any of the radiant section 113, convection section 114, and/or stack 116).

Burner 104 operational parameters may further be monitored using a flame scanner 149. Flame scanners 149 operate to analyze frequency oscillations in ultraviolet and/or infrared wavelengths of one or both of the main burner flame or the burner pilot light.

FIG. 1 also shows an air handling damper 152 that is located prior to the burner air register 120. The air-handling damper 152 includes any damper that impacts air-flow into the heater 102, such as a duct damper, variable speed fan, fixed-speed fan with air throttling damper, etc.) In certain system configurations, a single air input (including a given fan 124) supplies air to a plurality of burners, or a plurality of zones within a given heater. There may be any number of fans (e.g., forced fan 124), temperature sensors (e.g., air temperature sensor 144), air humidity sensors (e.g., air humidity sensor 146), air pressure sensors (e.g., pre-burner air register air pressure sensor 148) for a given configuration. Further, any of these air-side sensors may be located upstream or downstream from the air handling damper 152 without departing form the scope hereof.

The process controller 128 may further monitor fuel-side measurements and control fuel flow into the burner 104. Fuel-side measurement devices include one or more of flow sensor 154, fuel temperature sensor 156, and fuel-pressure sensor 158. The fuel-side measurement devices are coupled within or to the fuel supply line(s) 160 to measure characteristics of the fuel flowing into the burner 104. The flow sensor 154 may be configured to sense flow of the fuel through the fuel supply line 160. The fuel-temperature sensor 156 detects fuel temperature in the fuel supply line 160, and includes known temperature sensors such as a thermocouple. The fuel-pressure sensor 158 detects fuel-pressure in the fuel supply line 160.

The fuel line(s) 160 may have a plurality of fuel control valves 162 located thereon. These fuel control valves 162 operate to control the flow of fuel through the supply lines 160. The fuel control valves 162 are typically digitally controlled via control signals generated by the process controller 128. FIG. 1 shows a first fuel control valve 162(1) and a second fuel control valve 162(2). The first fuel control valve 162(1) controls fuel being supplied to all burners located in the heater 102. The second fuel control valve 162(2) controls fuel being supplied to each individual burner 104 (or a grouping of burners in each heater zone). There may be more or fewer fuel control valves 162 without departing from the scope hereof. Further, as shown, there may be a grouping of fuel-side measurement devices between individual components on the fuel supply line 160. For example, a first flow sensor 154(1), first fuel temperature sensor 156(1), and first fuel-pressure sensor 158(1) are located on the fuel supply line 160 between the fuel source 108 and the first fuel control valve 162(1). A second flow sensor 154(2), second fuel temperature sensor 156(2), and second fuel-pressure sensor 158(2) are located on the fuel supply line 160 between the first fuel control valve 162(1) and the second fuel control valve 162(2). Additionally, a third flow sensor 154(3), third fuel temperature sensor 156(3), and third fuel-pressure sensor 158(3) are located on the fuel supply line 160 between the second fuel control valve 162(2) and the burner 104. The third fuel temperature sensor 156(3), and third fuel-pressure sensor 158(3) may be configured to determine flow, temperature, and pressure respectively of an air/fuel mixture for pre-mix burners discussed above with respect to FIG. 5.

The process controller 128 may also measure process-side temperatures associated with the processes occurring within the process tubes 106. For example, system 100 may further include one or more tube temperature sensors 168, such as a thermocouple, that monitor the temperature of the process tubes 106. The temperature sensor 168 may also be implemented using optical scanning technologies, such as an IR camera, and/or one of the TDLAS devices 147. Furthermore, the heater controller 128 may also receive sensed outlet temperature of the fluid within the process tubes 106 from process outlet temperature sensor (not shown), such as a thermocouple. The process controller 128 may then use these sensed temperatures (from the tube temperature sensors 168 and/or the outlet temperature sensor) to control firing rate of the burners 104 to increase or decrease the generated thermal energy 112 to achieve a desired process temperature.

FIG. 11 depicts a block diagram of the process controller 128 of FIG. 1 in further detail, in embodiments. The process controller 128 includes a processor 1102 communicatively coupled with memory 1104. The processor 1102 may include a single processing device or a plurality of processing devices operating in concert. The memory 1104 may include transitory and or non-transitory memory that is volatile and/or non-volatile.

The process controller 128 may further include communication circuitry 1106 and a display 1108. The communication circuitry 1106 includes wired or wireless communication protocols known in the art configured to receive and transmit data from and to components of the system 100. The display 1108 may be co-located with the process controller 128, or may be remote therefrom and displays data about the operating conditions of the heater 102 as discussed in further detail below.

Memory 1104 stores the sensor database 130 discussed above, which includes any one or more of fuel data 1110, air data 1118, heater data 1126, emissions data 1140, process-side data 1170, and any combination thereof. In embodiments, the sensor database 130 includes fuel data 1110. The fuel data 1110 includes fuel flow 1112, fuel temperature 1114, and fuel-pressure 1116 readings throughout the system 100 regarding the fuel being supplied to the burner 104. For example, the fuel flow data 1112 includes sensed readings from any one or more of the flow sensor(s) 154 in system 100 transmitted to the process controller 128. The fuel temperature data 1114 includes sensed readings from any one or more of the fuel temperature sensor(s) 156 in system 100 transmitted to the process controller 128. The fuel-pressure data 1116 includes sensed readings from any one or more of the fuel-pressure sensor(s) 158 in system 100 transmitted to the process controller 128. In embodiments, the fuel data 1110 may further include fuel composition information that is either sensed via a sensor located at the fuel source 108 or that is determined based on an inferred fuel composition such as that discussed in U.S. Provisional Patent Application No. 62/864,954, filed Jun. 21, 2019 and which is incorporated by reference herein as if fully set forth. The fuel data 1110 may also include data regarding other fuel-side sensors not necessarily shown in FIG. 1, but known in the art.

In embodiments, the sensor database 130 includes air data 1118 regarding the air being supplied to the burner 104 and heater 102. The air data 1118 includes air temperature data 1120, air humidity data 1122, and air pressure data 1124. The air temperature data 1120 includes sensed readings from any one or more of the air temperature sensor(s) 144 in system 100 transmitted to the process controller 128. The air humidity data 1122 includes sensed readings from any one or more of the air humidity sensor(s) 146 in system 100, and/or data from local weather servers, transmitted to the process controller 128. The air pressure data 1124 includes sensed readings from any one or more of the pre-burner air register air pressure sensor 148, and a post-burner air register air pressure sensor 150 (or any other air pressure sensor) in system 100 transmitted to the process controller 128. The air data 1118 may also include data regarding other air-side sensors not necessarily shown in FIG. 1, but known in the art.

In embodiments, the sensor database 130 includes heater data 1126. The heater data 1126 includes radiant-section temperature data 1128, convection-section temperature data 1130, stack-section temperature data 1132, radiant-section pressure data 1134, convection-section pressure data 1136, and stack-section pressure data 1138. The radiant-section temperature data 1128 includes sensed readings from the radiant temperature sensor(s) 142 of system 100 that are transmitted to the process controller 128. The convection-section temperature data 1130 includes sensed readings from the convection temperature sensor(s) 140 of system 100 that are transmitted to the process controller 128. The stack-section temperature data 1132 includes sensed readings from the stack temperature sensor(s) 138 of system 100 that are transmitted to the process controller 128. The radiant-section pressure data 1134 includes sensed readings from the radiant pressure sensor(s) 126 of system 100 that are transmitted to the process controller 128. The convection-section pressure data 1136 includes sensed readings from the convection pressure sensor(s) 127 of system 100 that are transmitted to the process controller 128. The stack-section pressure data 1136 includes sensed readings from the stack pressure sensor(s) 129 of system 100 that are transmitted to the process controller 128. The heater data 1126 may also include data regarding other heater sensors not necessarily shown in FIG. 1, but known in the art.

In embodiments, the sensor database 130 further includes emissions data 1140. The emissions data 1140 includes O₂ reading(s) 1142, CO reading(s) 1144, and NO_{X} reading(s) 1146. The O₂ reading(s) 1142 include sensed readings from the oxygen sensor 132 transmitted to the process controller 128. The CO reading(s) 1144 include sensed readings from the carbon monoxide sensor 134 transmitted to the process controller 128. The NO_{X} reading(s) 1146 include sensed readings from the NO_{X} sensor 136 transmitted to the process controller 128. The emissions data 1140 may also include data regarding other emissions sensors not necessarily shown in FIG. 1, but known in the art.

In embodiments, the sensor database 130 includes process-side data 1170 regarding the conditions of the process tubes 106 and the process occurring. The process-side data 1170 includes process tube temperature 1172, and the outlet fluid temperature 1174. The process tube temperature 1172 may include data captured by the process tube temperature sensor 168, discussed above. The outlet fluid temperature 1174 may include data captured by an outlet fluid sensor (not shown), such as a thermocouple. The process-side data 1170 may also include data regarding other process-side sensors not necessarily shown in FIG. 1, but known in the art.

Data within the sensor database 130 is indexed according to the sensor providing said readings. Accordingly, data within the sensor database 130 may be used to provide real-time operating conditions of the system 100.

The memory 1104, in embodiments, further includes one or more of a fuel analyzer 1148, an air analyzer 1150, a draft analyzer 1152, an emissions analyzer 1154, a process-side analyzer 1176, and any combination thereof. Each of the fuel analyzer 1148, air analyzer 1150, draft analyzer 1152, emissions analyzer 1154, and process-side analyzer 1176 comprise machine readable instructions that when executed by the processor 1102 operate to perform the functionality associated with each respective analyzer discussed herein. Each of the fuel analyzer 1148, air analyzer 1150, draft analyzer 1152, emissions analyzer 1154, and process-side analyzer 1176 may be executed in serial or parallel to one another.

The fuel analyzer 1148 operates to compare the fuel data 1110 against one or more fuel alarm thresholds 1156. One common fuel alarm threshold 1156 includes fuel-pressure threshold that sets a safe operation under normal operating condition without causing nuisance shutdowns of the system 100 due to improperly functioning burner 104 caused by excess or low fuel-pressure. The fuel alarm thresholds 1156 are typically set during design of the system 100. The fuel analyzer 1148 may analyze other data within the sensor database 130 not included in the fuel data 1110, such as any one or more of air data 1118, heater data 1126, emissions data 1140, process-side data 1170, and any combination thereof to ensure there is appropriate air to fuel ratio within the heater to achieve the stoichiometric conditions for appropriate generation of the thermal energy 112.

The air analyzer 1150 operates to compare the air data 1118 against one or more air alarm thresholds 1158. One common air alarm threshold 1158 includes fan operating threshold that sets a safe operation condition of the forced fan 124 and/or stack fan 122 under normal operating condition without causing nuisance shutdowns of the system 100 due to improper draft within the heater 102 caused by excess or low air pressure throughout the system 100. The air alarm thresholds 1158 are typically set during design of the system 100. The air analyzer 1150 may analyze other data within the sensor database 130 not included in the air data 1118, such as any one or more of fuel data 1110, heater data 1126, emissions data 1140, process-side data 1170, and any combination thereof to ensure there is appropriate air to fuel ratio within the heater to achieve the stoichiometric conditions for appropriate generation of the thermal energy 112.

The draft analyzer 1152 operates to compare the heater data 1126 against one or more draft alarm thresholds 1160. One common draft alarm threshold 1160 includes heater pressure threshold that sets safe operation conditions of the heater 102 under normal operating condition without causing nuisance shutdowns or dangerous conditions of the system 100 due to positive pressure within the heater 102 (such as at the arch of the heater 102). The draft alarm thresholds 1160 are typically set during design of the system 100. The draft analyzer 1152 may analyze other data within the sensor database 130 not included in the heater data 1126, such as any one or more of fuel data 1110, air data 1118, emissions data 1140, process-side data 1170, and any combination thereof to ensure there is appropriate operating conditions within the heater 102 to achieve the stoichiometric conditions for appropriate generation of the thermal energy 112.

The emissions analyzer 1154 operates to compare the emissions data 1140 against one or more emission alarm thresholds 1162. One emissions alarm threshold 1162 include a minimum and maximum excess oxygen level that sets safe operation conditions of the heater 102 under normal operating condition without causing nuisance shutdowns or dangerous conditions of the system 100 due to too little or too much oxygen within the heater 102 during creation of the thermal energy 112. Other emission alarm thresholds 1162 include pollution limits set by environmental guidelines associated with the location in which system 100 is installed. The emission alarm thresholds 1162 are typically set during design of the system 100. The emissions analyzer 1154 may analyze other data within the sensor database 130 not included in the emissions data 1140, such as any one or more of fuel data 1110, air data 1118, heater data 1126, process-side data 1170, and any combination thereof to ensure there is appropriate operating conditions within the heater 102 to achieve the stoichiometric conditions for appropriate generation of the thermal energy 112.

The process-side analyzer 1176 operates to compare the process-side data 1170 against one or more process thresholds 1178. One common process threshold 1178 includes a desired outlet temperature to achieve efficient process conversion in the process tubes 106. Another example process threshold 1178 includes a maximum temperature threshold of the process tube 106 at which the process tube 106 is unlikely to fail. The process-side analyzer 1176 may analyze other data within the sensor database 130 not included in the process-side data 1170, such as any one or more of fuel data 1110, air-data 1118, heater data 1126, emissions data 1140, and any combination thereof to ensure there is appropriate air to fuel ratio within the heater to achieve the stoichiometric conditions for appropriate generation of the thermal energy 112.

The fuel threshold 1156, air threshold 1158, draft threshold 1160, emissions threshold 162 and process threshold 1178, and any other thresholds discussed herein may differ from system to system. They may be based on the amount of deviation from an expected value that an operator is willing to allow. The thresholds discussed herein may be set based on sensor and other hardware error tolerances. The thresholds discussed herein may be set based on regulations allowing certain tolerances for emissions or other operating conditions. The thresholds discussed herein may be set according to safety conditions for operating the heater 102.

The thresholds may also be set based on an uncertainty associated with calculated or predicted values, such as an artificial intelligence engine uncertainty. The uncertainties may be identified using the intelligent prediction engine discussed below. In such embodiments, the systems and methods herein may accommodate error ranges to provide a prediction confidence region around the output of an expected value that is then compared to sensed values to trigger one or more of the control signals 1164, alarms 1166 and/or displayed operating conditions 1168 when the sensed value deviates from the expected value past one or more of the fuel threshold 1156, air threshold 1158, draft threshold 1160, emissions threshold 162 and process threshold 1178. The sensors used to capture sensed data (e.g., the real-time sensed data and/or historical data of the system) may not be entirely accurate resulting in a sensor-based calculation uncertainty value. The sensor-based calculation uncertainty value is typically a fixed percentage that can change based on a calculated value (e.g., sensors are X % efficient when measuring temperatures across a first range, and Y % efficient across a second range). Similarly, the artificial intelligence engine may have an AI uncertainty that varies based on given inputs to the artificial intelligence engine. The AI engine, for example, models historical combined data distributions and analyzes statistical deviations of the current distribution on a scale of 0 to 100%. The prediction confidence region allows a given prediction by the physics-based calculations and/or the AI-based engine to accommodate variances in the associated data. The prediction confidence region may be calculated based on a predicted value plus or minus an uncertainty value based on one or both of the sensor-based calculation uncertainty value and/or the AI-engine uncertainty. The uncertainty value may be, for example, the sum of the sensor-based calculation uncertainty value and/or the AI-engine uncertainty. The uncertainty value may be, for example, the square root of the sensor-based calculation uncertainty, squared, plus the AI-engine uncertainty, squared. Use of an uncertainty value when comparing sensed and expected/predicted/calculated values prevents false identifications of conditions within the process heater 102 in the system. Use of a prediction confidence region based on an uncertainty value as discussed above may apply to any one or more of the “expected”, “modeled”, “predicted”, “calculated” values or the like discussed in this application.

The fuel analyzer 1148, the air analyzer 1150, the draft analyzer 1152, the emissions analyzer 1154, and the process-side analyzer 1176 operate to create one or more of control signals 1164, alarms 1166, and displayed operating conditions 1168. The control signals 1164 include signals transmitted from the process controller 128 to one or more components of the system 100, such as the dampers 118, air registers 120 (if electrically controlled), fans 122, 124, and valves 162. The alarms 1166 include audible, tactile, and visual alarms that are generated in response to tripping of one or more of the fuel alarm threshold 1156, air alarm threshold 1158, draft alarm threshold 1160, and emission alarm threshold 1162. The displayed operating conditions 1168 include information that is displayed on the display 1108 regarding the data within the sensor database 130 and the operating conditions analyzed by one or more of the fuel analyzer 1148, air analyzer 1150, draft analyzer 1152, emissions analyzer 1154, and process-side analyzer 1176.

Referring to FIG. 1, one or more of the fuel analyzer 1148, the air analyzer 1150, the draft analyzer 1152, the emissions analyzer 1154 and the process-side analyzer 1176 may be entirely or partially implemented on an external server 164. The external server 164 may receive some or all of the data within the sensor database 130 and implement specific algorithms within each of the fuel analyzer 1148, the air analyzer 1150, the draft analyzer 1152, the emissions analyzer 1154 and the process-side analyzer 1176. In response, the external server 164 may transmit one or more of the control signals 1164, the alarms 1166, and/or the displayed operating conditions 1168 back to the process controller 128.

When unwanted excess air (also referred to as tramp air) enters the heater 102, the excess oxygen level sensed by the oxygen sensor 132 increases. Air is “unwanted” in that it is not expected during control of the system—all burners are controlled to have at least some amount of excess air to drive a desired amount of excess oxygen at the stack while maintaining safe and stoichiometric conditions for combustion. Conversely, the oxygen level sensed by the oxygen sensor 132 may lower for a variety of reasons such as: additional fuel entering the system (e.g., via a leak in the process tubes 106 causing excess material to enter the heater housing 102); when a burner air register is not moving when actuated; when something—e.g., debris, insulation, etc.—is blocking the air input at one or more burners 104, ambient air inlet blocked via insects and/or birds' nests, heater insulation falling into the burner 104 throat, etc.).

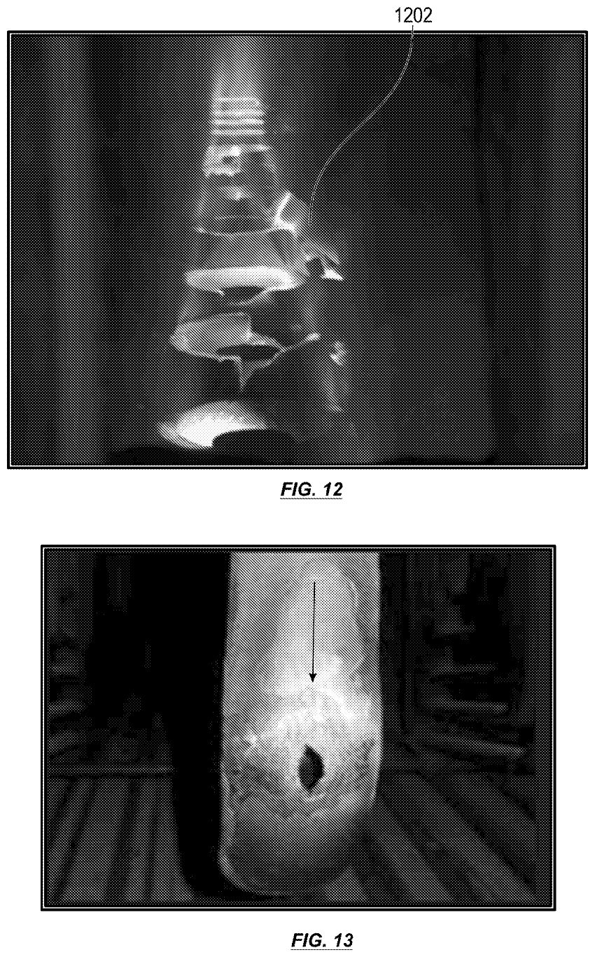

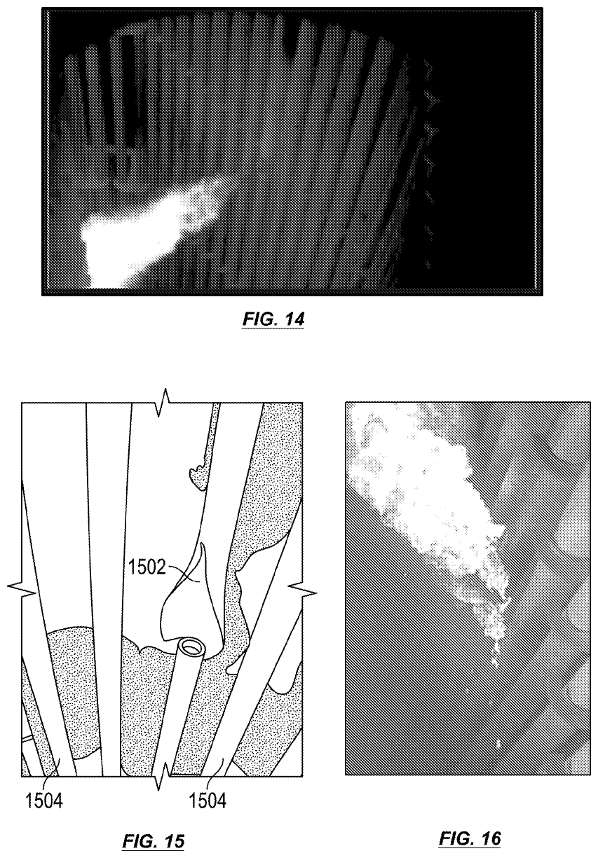

FIGS. 12-16 depict various operating conditions result in sensed oxygen readings by the oxygen sensor 132 that cause incorrect control of the input fuel/air ratio to the burner 104, in examples. FIG. 12 shows a tile 1202 fallen from the interior of the housing and blocking air input to a burner. FIG. 13 depicts one pin-hole that causes excess fuel to enter into the system for example as shown in the infrared image of FIG. 14. FIG. 15 shows a blown-open process tube 1502 causing significant release of fuel into the system as shown in FIG. 16. The polished look 1504 of the tubes adjacent the failed process tube 1502 in FIG. 15 indicates flame impingement causing inefficient or improper heating conditions within the process tube, which was likely the cause of the tube failure.

Significant excess air within the heater 102 or not enough air within the heater 102 causes an unbalanced stoichiometric condition for generating the thermal energy 112, thereby resulting in unfavorable (and often unsafe) operating conditions. Typically, the oxygen sensor output is trusted by operations personnel to be the primary indication that there is sufficient and proper air for combustion to occur safely. Currently, there are limited options for ensuring that the measured excess oxygen in the system is coming through the burners as designed. Visual analysis by a human operator is frequently required to check for conditions in the heater that may indicate excess or insufficient air. When there is excess tramp air in the system, if the operator is unaware and controlling based on the sensed oxygen levels by the oxygen sensor 132, the operator and/or heater controller 128, often reduces the input air to the burner because the global oxygen sensor 132 indicates there is too much air. Thus, the flames (e.g., thermal energy 112) from the burner 104 may extend too far from the burner 104 because the oxygen in the excess tramp air is being used to burn the extra fuel (because the controlled input fuel/air ratio is too high). These extended flames cause the process tubes 106 in the system to heat improperly resulting in inefficient or dangerous operation. Blocked input air in the system (see FIG. 12), or excess fuel in the system (see FIGS. 13-16) causes the operator or control system to increase the air flow through the burners, in attempts to raise the measured excess O2. In doing so, the burner air fuel ratio will be unintentionally driven to a fuel lean condition (more excess air going through the burners than is being measured), which can result in unstable burners which is also dangerous and/or inefficient condition.

### Intelligent Analytics of a Combustion System

The present disclosure realizes that large amount of data is captured using the above-described sensors, and stored in a data historian associated with the combustion system. The data historian may include historical data (e.g., time-series data) of any one or more of the fuel data 1110, air data 1118, heater data 1126, emissions data 1140, and process-side data 1170. This disclosure acknowledges that this data may be utilized, along with first-principle physics calculations to identify anomalies within the combustion system, and provide recommendations for improving operation of the combustion system (such as maintenance recommendations, fuel-side control schemes, air-side control schemes, process-side control schemes, etc.). However, first-principle physics-based calculations have inherent uncertainties because the measurement devices used to obtain the historical data are not perfectly accurate. The present disclosure resolves this hardware-based uncertainty by identifying a prediction confidence region that accommodates uncertainty. This prediction confidence region is not only based on the fixed hardware uncertainty (e.g. standard hardware uncertainty values found in the technical specifications of the given hardware), but also includes historical shifts in the data as determined using artificial intelligence-based abnormal behavior. Using the prediction confidence region, as described below, results in fewer false-positive identifications of potentially unstable conditions in the combustion system.

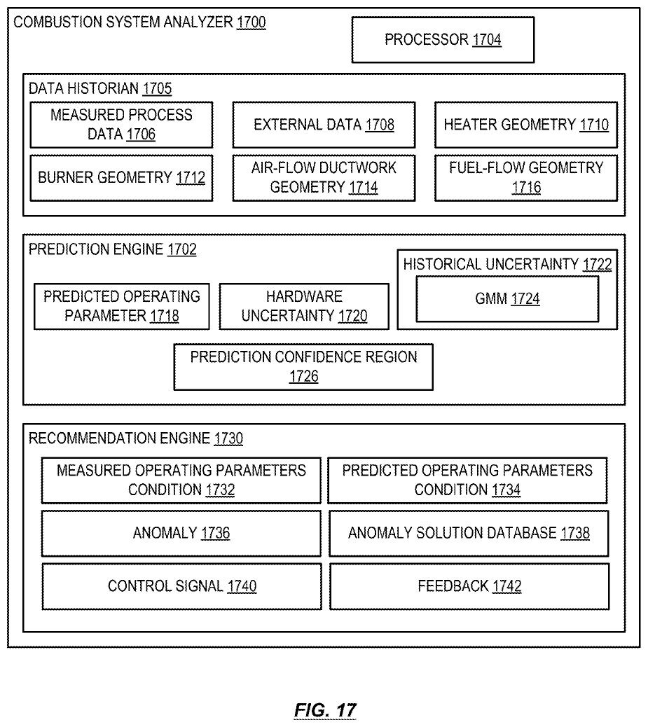

FIG. 17 depicts a combustion system analyzer 1700 for use in identifying anomalies within a combustion system, in an embodiment. Combustion system analyzer 1700 may be an example of any one or more of fuel analyzer 1148, air analyzer 1150, draft analyzer 1152, emissions analyzer 1154, and/or process-side analyzer 1176. Combustion analyzer 1700 may be implemented on-site at the combustion system (e.g., as a component of heater controller 128), or may be implemented on the “cloud” at an external server off-site from the combustion system where data is transmitted from the combustion system (e.g., from sensor database 130) to the external server and outputs from the combustion analyzer 1700 are transmitted back to the combustion system (e.g., to heater controller 128). The combustion analyzer 1700 includes a prediction engine 1702. Prediction engine 1702 includes computer readable instructions that when executed by a processor 1704 (which may be an example of processor 1102 of FIG. 11 above, or a processor located on an external server off-site from the combustion system), operate to implement the functionality of the prediction engine 1702 described below.

The combustion system analyzer 1700 includes a data historian 1705. The combustion system analyzer 1700 receives measured process data 1706 which is stored in the data historian 1705. The measured process data 1706 may include any of the data sensed by any sensor at and/or within the combustion system (e.g., heater 102), including any of the data within sensor database 130, described above. The combustion system analyzer 1700 may further receive, and store in the data historian 1705, external data 1708, which may include weather information about ambient conditions surrounding the combustion system. The combustion system analyzer 1700 may further receive, and store in the data historian 1705, one or more of heater-specific data 1710, which may include geometry about the heater (e.g., shape, size of the heater 102), burner geometry 1712 (e.g., shape, size, number of burners, burner configurations, burner locations, etc.), air-flow ductwork geometry 1714 (e.g., number of air inlets/outlets, shape, size, etc.), fuel-flow geometry 1716 (e.g., number of fuel inlets/outlets, valve configurations, shape, size, etc.), and any other information externally-sourced used to calculate operating parameters of the combustion system. The measured process data 1706, external data 1708, and heater-specific data 1710 may be time-series data including historical values of given data points. The burner geometry 1712, air-flow ductwork geometry 1714, and fuel-flow geometry 1716 is likely static data because these are unlikely to change. However, if any of the burner geometry 1712, air-flow ductwork geometry 1714, and fuel-flow geometry 1716 is changeable (e.g., via changing of air-flow valves or fuel-flow valves, or changing of the burner geometry), then such historical changes will also be stored in the associated data.

Using the measured process data 1706, and any one or more of the external data 1708, heater geometry 1710, burner geometry 1712, air-flow ductwork geometry 1714, and fuel-flow geometry 1716, the prediction engine 1702 applies first-principle physics calculations to determine one or more predicted operating parameter 1718 of the combustion system. Examples of the predicted operating parameters 1718 include, but are not limited to, expected heat release (at one or various locations within the heater 102), expected oxygen levels e.g., wet O₂ level) based on fuel mass flow, expected oxygen levels e.g., wet O₂ level) based on fuel gas pressure, etc. The predicted operating parameters 1718 may include categorized-types of operating parameters, such as fuel-side parameters, air-side parameters, process-side parameters, etc. Furthermore, the predicted operating parameters 1718 may be calculated to correspond to a specific location within the heater 102 (e.g., in the radiation section 113, convection section 114, stack section 116, or specific locations within each section 113, 114, 116, etc.

The prediction engine 17002 may further calculate a hardware uncertainty value 1720. The hardware uncertainty value 1720 may be a fixed value (e.g., a value that does not change over time for each set of variables used to determine the predicted operating parameter 1718) and is based on the instrument measurement uncertainty for each sensor that obtains a piece of data used to calculate the given predicted operating parameter 1718. The hardware uncertainty value 1720 acknowledges that every measurement has some uncertainty associated with it. Thus, the hardware uncertainty value propagates the uncertainty (which may be defined in the technical data sheet of a given measurement device, or calculated on-field) associated with all calculations necessary to determine the predicted operating parameter.

In one embodiment, the hardware uncertainty value 1720 is propagated according to the law of propagation of uncertainties, and assuming all constituent variables of an equation are independent. In other words, the covariance of all combinations of constituent variables is zero. For example, given a calculated predicted operating parameter (Y) that is a function of several variables as shown in equation 1, below, and the associated unceratinties of the individual variables: ωₓ₁, ωₓ₂, ωₓ₃, . . . , ω_{xN}.

Y=f(x₁,x₂,x₃, . . . ,x_{N}) Eq. 1

The uncertainty of Y is calculated using equation 2, below:

$${ω}_{Y} = \sqrt{{Σ}_{i = 1}^{N} {( {ω}_{{x}_{i}} \frac{\partial f}{\partial {x}_{i}} )}^{2}} \qquad Eq . 2$$

The uncertainties for the calculated quantities utilize the base measurement uncertainties. The uncertainties for a given sensor may be default based on the technical datasheet associated with that sensor, or the default uncertainty may be overwritten based on actual measurement uncertainties with appropriate attributes given.

The prediction engine 1702 further calculates a historical uncertainty 1722. The historical uncertainty 1722 may be based on an artificial intelligence-based analysis of historical combined data distribution defining how far away has the current distribution shifted from the historical data in the data historian 1705. The historical uncertainty 1722 may be on a scale of 0 to 100%. To generate the historical uncertainty 1722, the prediction engine 1702 may model a statistical deviation of each variable (e.g., measurement) used to calculate the given predicted operating parameter 1718. These statistical deviations may then be fused into a multi-dimension space distribution.

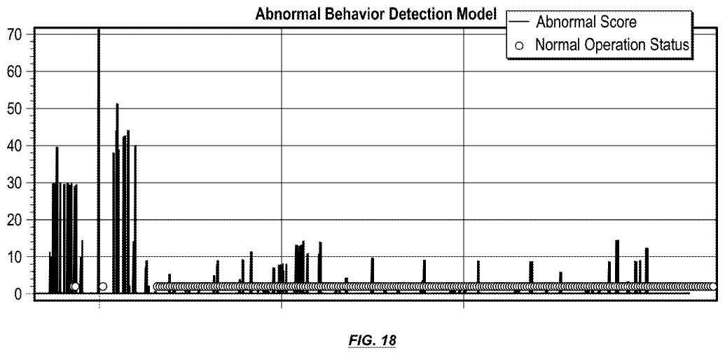

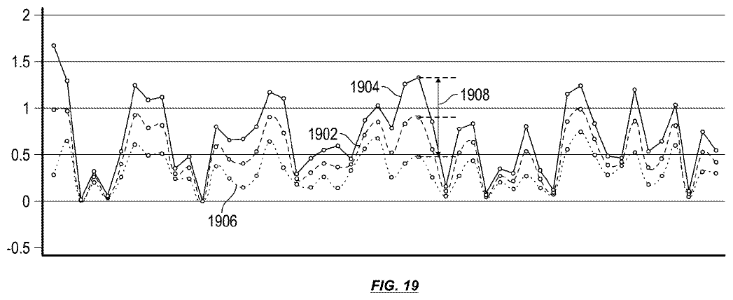

The model of statistical deviation of each measurement may be based on a Gaussian Mixture Model (GMM) 1724, to ensure distribution objectively represents the actual distribution of the input variable in the predicted operating parameter 1718 instead of either considering everything to be gaussian distributed or incorrectly assuming that the distribution is a fixed format such as Rayleigh or Poisson distribution etc. Using GMM 1724, the prediction engine 1702 accurately describes the distributions for each variable used in the predicted operating parameter 1718, as well as finds the cluster centroid for all the input variables combined. FIG. 18 shows the impact of using a GMM to establish the historical uncertainty 1722 in association with the prediction confidence score. As opposed to just using gaussian models, the GMM allows for some drift (e.g., approximately 10-14%, in the example of FIG. 18, although more or less drift may occur without departing from the scope hereof) without indicating abnormal operating status.

Using the GMM 1724 model, the prediction engine 1702 identifies the historical uncertainty 1722 that describes how much drift is present, for each incoming input variable (or set of variables) used to calculate the predicted operating parameter 1718, as compared to the historical norm for that variable (or collection of variables) by a scale from 0 to 100%. This provides an advantage of a systematic and wholistic view of the historical data in the data historian 1705, where 100% “drift” indicates a complete drift with a given Probability of False Alarm (PFA).

In embodiments, the hardware uncertainty 1720, and the historical uncertainty 1722 may be calculated each time a data entry comes into the data historian 1705. In embodiments, each of the hardware uncertainty 1720 and the historical uncertainty 1722 is calculated each time the predicted operating parameter 1718 is calculated. Each predicted operating parameter 1718 may be calculated periodically, such as every X seconds, minutes, or hours. Furthermore, certain predicted operating parameters may be calculated at a greater frequency than others, depending on the importance of the given predicted operating parameter to the current operation of the combustion system. In embodiments, the predicted operating parameter 1722 is calculated on-demand in response to the prediction engine 1702 receiving a request (e.g., from an operator control interface which may be on the heater controller 128 or an external device such as a handheld device used by a field-operator).

The prediction engine 1702 uses the hardware uncertainty 1720 and the historical uncertainty 1722 to generate a prediction confidence region 1726 for each predicted operating parameter 1718. The prediction confidence region 1726 results in fewer false-positive identifications of potentially unstable conditions in the combustion system.

In an embodiment, the prediction confidence region 1726 is defined as P±\sqrt{U_{HW}²+U_{Hist}²}; where P is the predicted operating parameter 1718 value; U_{HW} is the hardware uncertainty 1720 that includes uncertainties for each variable propagated throughout the calculations necessary to generate the predicted operating parameter 1718; and U_{Hist} is the historical uncertainty 1722 that defines how far away has the current distribution shifted from the historical data in the data historian 1705. In an embodiment, the prediction confidence region 1726 is defined as P±(U_{HW}+U_{Hist}).

The prediction confidence region 1726 may then be used by the heater controller 128 to provide control of the combustion system. For example, the prediction confidence region 1726 may be compared against one or more thresholds (e.g., one or more of fuel threshold 1156, air threshold 1158, draft threshold 1160, emissions threshold 1162, and process threshold 1178) to determine when a potential threshold is reached/breached, and selecting a control output to remedy the breach (e.g., automatically control the combustion system to no longer breach the threshold, shut down the combustion system, display the breach to an operator of the combustion system, etc.).

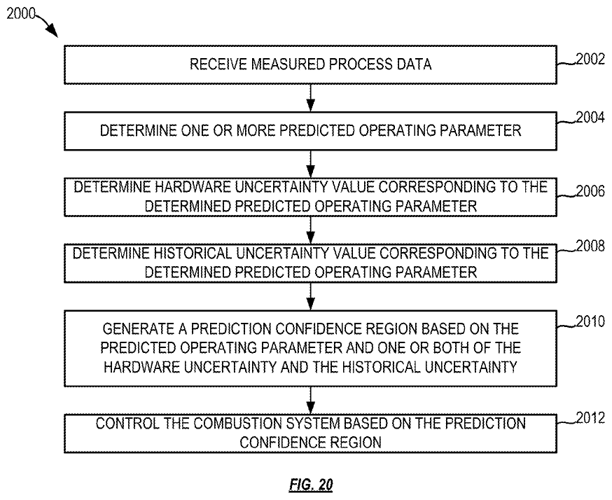

FIG. 19 depicts an example time-series graph of a predicted operating parameter 1718, and the associated prediction confidence region 1726. Line 1902 represents a time series of the predicted operating parameter value 1718. Line 1904 represents a time series of the predicted operating parameter value 1718 plus the \sqrt{U_{HW}²+U_{Hist}²}. Line 1906 represents a time series of the predicted operating parameter value 1718 minus the \sqrt{U_{HW}²+U_{Hist}²}. The range 1908 between line 1904 and 1906 represents the prediction confidence region. As discussed above, thresholds (e.g., one or more of fuel threshold 1156, air threshold 1158, draft threshold 1160, emissions threshold 1162, and process threshold 1178) may be set based on an uncertainty associated with calculated or predicted values. The prediction confidence region 1726 may be used to set the thresholds, or to identify when a given predicted value is approaching/breaching a given threshold. As discussed above, further false positives are achieved using the prediction confidence region 1726 discussed herein.

The combustion system analyzer 1700 may further include a recommendation engine 1730. Recommendation engine 1730 may be standalone from prediction engine 1702, or may be a component thereof. Recommendation engine 1702 includes computer readable instructions that when executed by processor 1704, operate to implement the functionality of the prediction engine 1702 described below.

Recommendation engine 1730 compares measured operating parameter conditions 1732 against predicted operating parameter condition(s) 1734. To make the comparison, recommendation engine 1730 may compare at least one measured operating parameter 1732 from the data historian 1705 against one predicted operating parameter 1718. The comparison to the predicted operating parameter 1718 may, but need not necessarily require, inclusion of the prediction confidence region 1726 determined by the prediction engine 1702 as discussed above. In embodiments, the recommendation engine 1730 compares a first measured operating parameter condition 1732 against at least one corresponding first predicted operating parameter condition 1734, and a second measured operating parameter condition 1732 against at least two different corresponding second predicted operating parameter conditions 1736. In other words, for a given piece of measurable data (e.g., O₂, NOX, CO, air pressure, heat release, or any other measurable value within the heater 102), there may be more than one way to calculate a predicted operating parameter 1718 to correlate to that measurable value. For example, for a particular measured zoneO₂ value, the corresponding predicted wet O₂ value (e.g., the corresponding predicted operating parameter 1718) may be calculated based on fuel mass flow and/or fuel gas pressure using information from the data historian 1705. Thus, in an example, the first measured operating parameter condition 1732(1) is measured heat release (in BTU/hr) is compared to a corresponding first predicted operating parameter condition 1734(1) of predicted heat release (in BTU/hr). However, the second measured operating parameter condition 1732(2) is ZoneO₂ (sensed using an oxygen sensor such as O2 sensor 132) is compared to a predicted ZoneO₂ value based on fuel mass flow and a predicted ZoneO₂ based on fuel gas pressure. The relationship between the first measured operating parameter condition 1732(1), the first measured operating parameter condition 1734(1), the second measured operating parameter condition 1732(2), and each of the two different second predicted operating parameter conditions 1734(2, A-B) may allow the recommendation to identify a given anomaly 1736.

The recommendation engine 1730 may then compare the identified anomaly 1736 to an anomaly solution database 1738 to generate a control signal 1740 to take action with respect to the anomaly 1736. The control signal 1740 may be a recommendation list that instructs the operator of the combustion system to implement a prioritized list of potential remedies (which may be prioritized based on cost-to-implement, fastest-to-implement, ease-to-implement, past success rate (based on the same combustion system, or other combustion systems), etc.). The control signal 1740 may automatically control any component of the combustion system that is electronically controllable by the heater controller 128. The control signal 1740 may automatically shut down the combustion system when the anomaly 1736 is one that is a safety breach.

The recommendation engine 1730 may receive feedback 1742 regarding the output control signal 1740. The recommendation engine 1730 may then update the anomaly solution database 1738 based on the feedback 1742. Feedback 1742 may be from a different combustion system than used to generate the data historian 1705. In other words, the anomaly solution database 1738 may accumulate historical analysis of enacted anomaly solutions from a plurality of combustion systems to provide intelligent recommendations for a given anomaly. This allows the recommendation engine 1730 to prioritize potential solutions to a given anomaly 1736, resulting in more efficient and safe operation and maintenance of combustion systems utilizing the recommendation engine 1730.

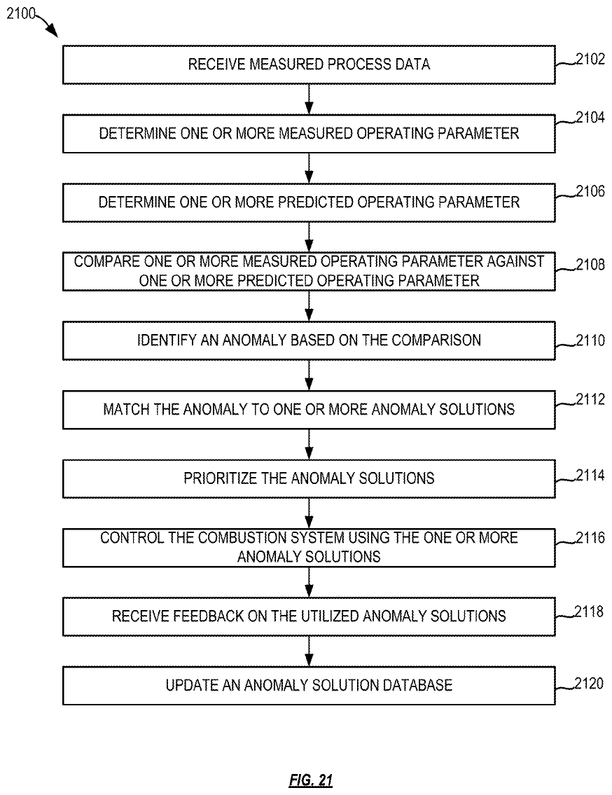

FIG. 20 depicts a method 2000 for controlling a combustion system based on a prediction confidence region, in an embodiment. Method 2000 is implemented using the system described above with respects to FIGS. 1-19, such as via execution of the prediction engine 1702.

In block 2002, the method 2000 receives measured process data. In one example of block 2002, the combustion system analyzer 1700 receives measured process data 1706 which is stored in the data historian 1705.

In block 2004, the method 2000 determines one or more predicted operating parameters from the measured process data. In one example of block 2004, the combustion system analyzer 1700, using the measured process data 1706, and any one or more of the external data 1708, heater geometry 1710, burner geometry 1712, air-flow ductwork geometry 1714, and fuel-flow geometry 1716, the prediction engine 1702 applies first-principle physics calculations to determine one or more predicted operating parameter 1718 of the combustion system.

In block 2006, the method 2000 determines hardware uncertainty value corresponding to the predicted operating parameter. In one example of block 2004, the combustion system analyzer 1700 determines a hardware uncertainty value 1720. The hardware uncertainty value 1720 may be a value that does not change over time and is based on the instrument measurement uncertainty for each sensor that obtains a piece of data used to calculate the given predicted operating parameter 1718. The hardware uncertainty value may be calculated using equations 1 and 2, above.

In block 2008, the method 2000 determines historical uncertainty value corresponding to the predicted operating parameter. In one example of block 2004, the combustion system analyzer 1700 determines a historical uncertainty 1722. The historical uncertainty 1722 may be based on an artificial intelligence-based analysis of historical combined data distribution defining how far away has the current distribution shifted from the historical data in the data historian 1705. The historical uncertainty 1722 may be on a scale of 0 to 100%. To generate the historical uncertainty 1722, the prediction engine 1702 may model a statistical deviation of each measurement used to calculate the given predicted operating parameter 1718. These statistical deviations may then be fused into a multi-dimension space distribution. The model of statistical deviation of each measurement may be based on a Gaussian Mixture Model (GMM) 1724. Using the GMM 1724 model, the prediction engine 1702 identifies the historical uncertainty 1722 that describes how much drift is present, for each incoming input variable (or collection of variables) used to calculate the predicted operating parameter 1718, as compared to the historical norm for that variable (or collection of variables) by a scale from 0 to 100%. This provides an advantage of a systematic and wholistic view of the historical data in the data historian 1705, where 100% “drift” indicates a complete drift with a given Probability of False Alarm (PFA).

In block 2010, the method 2000 determines a prediction confidence region based on the predicted operating parameter and one or both of the hardware uncertainty and the historical uncertainty. In one example of block 2010, the combustion system analyzer 1700 uses the hardware uncertainty 1720 and the historical uncertainty 1722 to generate a prediction confidence region 1726 for each predicted operating parameter 1718. The prediction confidence region 1726 results in fewer false-positive identifications of potentially unstable conditions in the combustion system. In an embodiment of block 2010, the prediction confidence region is defined as P±\sqrt{U_{HW}²+U_{Hist}²}; where P is the predicted operating parameter value; U_{HW} is the hardware uncertainty that includes uncertainties for each variable propagated throughout the calculations necessary to generate the predicted operating parameter; and U_{Hist} is the historical uncertainty that defines how far away has the current distribution shifted from the historical data in the data historian. In an embodiment of block 2010, the prediction confidence region is defined as P±(U_{HW}+U_{Hist}).

In embodiments, blocks 2004-2010 are executed each time the predicted operating parameter 1718 is calculated. Each predicted operating parameter 1718 may be calculated periodically, such as every X seconds, minutes, or hours. Furthermore, certain predicted operating parameters may be calculated at a greater frequency than others, depending on the importance of the given predicted operating parameter to the current operation of the combustion system. In embodiments, blocks 2004-2010 are executed on-demand in response to the prediction engine 1702 receiving a request (e.g., from an operator control interface which may be on the heater controller 128 or an external device such as a handheld device used by a field-operator).

In block 2012, the method 2000 controls the combustion system based on the prediction confidence region. In an embodiment of block 2012, the heater controller 128 uses the prediction confidence region by comparing it against one or more thresholds (e.g., one or more of fuel threshold 1156, air threshold 1158, draft threshold 1160, emissions threshold 1162, and process threshold 1178) to determine when a potential threshold is reached/breached.

FIG. 21 depicts a method 2100 for providing intelligent control of a combustion system, in an embodiment. Method 2000 is implemented using the system described above with respects to FIGS. 1-19, such as via execution of the recommendation engine 1730.

In block 2102, the method 2100 receives measured process data. In one example of block 2102 the combustion system analyzer 1700 receives measured process data 1706 which is stored in the data historian 1705.

In block 2104, the method 2100 determines one or more measured operating parameters. In one example of block 2104 the recommendation engine determines at least one measured operating parameter 1732 from the data historian 1705.

In block 2106, the method 2100 determines one or more predicted operating parameters. In one example of block 2106 the recommendation engine determines at least one predicted operating parameter 1734. The predicted operating parameter 1734 may be the predicted operating parameter 1718, including (or not including) the prediction confidence region 1726 determined by the prediction engine 1702 as discussed above, such as using method 2000.

In block 2108, the method 2100 compares one or more measured operating parameters against one or more predicted operating parameters. In one example of block 2108 the recommendation engine 1730 compares measured operating parameters conditions 1732 against predicted operating parameters condition(s) 1734. In one embodiment of block 2108, the recommendation engine 1730 compares one or more first measured operating parameter condition 1732 against at least one corresponding first predicted operating parameter condition 1734, and a second measured operating parameter condition 1732 against at least two different corresponding second predicted operating parameter conditions 1736. In other words, for a given piece of measurable data (e.g., O₂, NOX, CO, air pressure, heat release, or any other measurable value within the heater 102), there may be more than one way to calculate a predicted operating parameter 1718 to correlate to that measurable value. For example, for a particular measured zoneO₂ value, the corresponding predicted wet O₂ value (e.g., the corresponding predicted operating parameter 1718) may be calculated based on fuel mass flow and/or fuel gas pressure using information from the data historian 1705. Thus, in an example, the first measured operating parameter condition 1732(1) is measured heat release (in BTU/hr) is compared to a corresponding first predicted operating parameter condition 1734(1) of predicted heat release (in BTU/hr). However, the second measured operating parameter condition 1732(2) is ZoneO₂ (sensed using an oxygen sensor such as O2 sensor 132) is compared to a predicted ZoneO₂ value based on fuel mass flow and a predicted ZoneO₂ based on fuel gas pressure. The relationship between the first measured operating parameter condition 1732(1), the first measured operating parameter condition 1734(1), the second measured operating parameter condition 1732(2), and each of the two different second predicted operating parameter conditions 1734(2, A-B) may allow the recommendation to identify a given anomaly 1736.

In block 2110, the method 2100 identifies an anomaly based on the comparison in block 2108. In one example of block 2110 the recommendation engine 1730 identifies the presence, or no presence, of an anomaly in the operation of the combustion system based on the comparison completed in block 2008.

In block 2112, the method 2100 matches the identified anomaly to one or more anomaly solutions. In one example of block 2112 the recommendation engine 1730 compares the identified anomaly 1736 to the anomaly solution database 1738.

In block 2114, the method 2100 prioritizes the anomaly solutions. In one example of block 2114, the recommendation engine 1730 prioritizes the anomaly solutions identified in block 2112 based on most-likely to succeed solutions. In one example of block 2114, the recommendation engine 1730 prioritizes the anomaly solutions identified in block 2112 based on fastest-to-implement. In one example of block 2114, the recommendation engine 1730 prioritizes the anomaly solutions identified in block 2112 based on cheapest-to-implement.

In block 2116, the method 2100 controls the combustion system using the one or more anomaly solutions identified in block 2112 or 2114. In one example of block 2116 the recommendation engine 1730 transmits the control signal 1740 to the heater controller 128. The control signal 1740 may include the one or more anomaly solutions (prioritized if block 2114 is implemented) to the heater controller 128 for execution thereby.

In block 2118, the method 2100 receives feedback on the utilized anomaly solutions. In one example of block 2118, the recommendation engine 1730 receives feedback 1742. Feedback 1742 may be from a different combustion system than used to generate the data historian 1705. In other words, the anomaly solution database 1738 may accumulate historical analysis of enacted anomaly solutions from a plurality of combustion systems to provide intelligent recommendations for a given anomaly. This allows the recommendation engine 1730 to prioritize potential solutions to a given anomaly 1736, resulting in more efficient and safe operation and maintenance of combustion systems utilizing the recommendation engine 1730.

In block 2120, the method 2100 updates an anomaly solution database. In one example of block 2120, the recommendation engine 1730 updates the anomaly database 1738 based on the feedback 1742 for future reference and generation of the anomaly solutions, and prioritization thereof.

The following examples are intended to be non-limiting in scope, and establishes an example of method 2100 and the prediction engine 1730.

In a first scenario, a first measured operating parameter condition (e.g., measured operating parameter condition 1732) is a first value of a heat release (in BTU/hr), and a second measured operating parameter condition is a value of a zoneO₂. In the first scenario, a predicted operating parameter condition (e.g., predicted operating parameter condition 1734) results in a predicted heat release (in BTU/hr) that is equal to (e.g., measured heat release value is exactly equal to the predicted heat release value, predicted heat release value is equal to the measured heat release value within a given threshold, and/or the measured heat release is within a predicted heat release having predicted confidence region as discussed above). In the first scenario, a predicted wetO₂ based on fuel mass flow calculations is equal to the measured zoneO₂ (e.g., predicted wetO₂ value based on fuel mass flow is exactly equal to the measured wetO₂ value, predicted wetO₂ value based on fuel mass flow is exactly equal to the measured wetO₂ value plus or minus a given threshold, and/or the measured zoneO₂ is within a predicted wetO₂ based on fuel mass flow having predicted confidence region as discussed above). In the first scenario, a predicted wetO₂ based on fuel gas pressure calculations is equal to the measured zoneO₂ (e.g., predicted wetO₂ value based on fuel gas pressure is exactly equal to the measured wetO₂ value, predicted wetO₂ value based on fuel gas pressure is exactly equal to the measured wetO₂ value plus or minus a given threshold, and/or the measured zoneO₂ is within a predicted wetO₂ based on fuel mass flow having predicted confidence region as discussed above). Because the heat release measured is equal to the predicted heat release, and the measured zoneO₂ is equal to the predicted wetO2 values, based on two different prediction calculations, it is reasonably understood that no anomaly exists and the heater is in healthy and stable condition.

In a second scenario, a first measured operating parameter condition (e.g., measured operating parameter condition 1732) is a first value of a heat release (in BTU/hr), and a second measured operating parameter condition is a value of a zoneO₂. In the second scenario, a predicted operating parameter condition (e.g., predicted operating parameter condition 1734) results in a predicted heat release (in BTU/hr) that is greater than (e.g., predicted heat release value is greater than the measured heat release value, predicted heat release value is greater than the measured heat release value plus or minus a given threshold amount, and/or the measured heat release is less than a predicted confidence region of a predicted heat release). In the second scenario, a predicted wetO₂ based on fuel mass flow calculations is equal to the measured zoneO₂ (e.g., predicted wetO₂ value based on fuel mass flow is exactly equal to the measured wetO₂ value, predicted wetO₂ value based on fuel mass flow is exactly equal to the measured wetO₂ value plus or minus a given threshold, and/or the measured zoneO₂ is within a predicted wetO₂ based on fuel mass flow having predicted confidence region as discussed above). In the second scenario, a predicted wetO₂ based on fuel gas pressure calculations is less than to the measured zoneO₂ (e.g., predicted wetO₂ value based on fuel gas pressure is less than the measured wetO₂ value, predicted wetO₂ value based on fuel gas pressure is less than to the measured wetO₂ value plus or minus a given threshold, and/or the predicted wetO₂ based on fuel gas pressure has a having predicted confidence region that is less than the measured zoneO₂).

Because the fuel gas pressure vs fuel mass flow has the given condition in the second scenario, the identified anomaly 1736 may be tip fouling, less burners that are on than expected in the given calculations to determine the predicted values, or the O2 meter used to measure the zoneO₂ value is faulty. The anomaly solution database 1738 may indicate to implement the following prioritized actions for tip fouling: validate tip fouling by looking at flame patterns, and/or clean fuel gas tips, and/or replace fuel gas tips. The validation step is prioritized because it is less-costly than cleaning and/or replacing the fuel gas tips. The anomaly solution database 1738 may indicate to implement the following action for less burners being on than expected: validate number of burners that are firing. The anomaly solution database 1738 may indicate to implement the following prioritized actions for faulty oxygen sensor: calibrate O₂ meter, replace O₂ meter.

In a third scenario, a first measured operating parameter condition (e.g., measured operating parameter condition 1732) is a first value of a heat release (in BTU/hr), and a second measured operating parameter condition is a value of a zoneO₂. In the third scenario, a predicted operating parameter condition (e.g., predicted operating parameter condition 1734) results in a predicted heat release (in BTU/hr) that is less than (e.g., predicted heat release value is less than the measured heat release value, predicted heat release value is less than the measured heat release value plus or minus a given threshold amount, and/or the measured heat release is greater than a predicted confidence region of a predicted heat release). In the third scenario, a predicted wetO₂ based on fuel mass flow calculations is greater than to the measured zoneO₂ (e.g., predicted wetO₂ value based on fuel mass flow is greater than the measured wetO₂ value, predicted wetO₂ value based on fuel mass flow is greater than to the measured wetO₂ value plus or minus a given threshold, and/or the predicted wetO₂ based on fuel mass flow has a having predicted confidence region that is greater than the measured zoneO₂). In the third scenario, a predicted wetO₂ based on fuel gas pressure calculations is greater than to the measured zoneO₂ (e.g., predicted wetO₂ value based on fuel gas pressure is greater than the measured wetO₂ value, predicted wetO₂ value based on fuel gas pressure is greater than to the measured wetO₂ value plus or minus a given threshold, and/or the predicted wetO₂ based on fuel gas pressure has a having predicted confidence region that is greater than the measured zoneO₂).

Because the fuel gas pressure vs fuel mass flow has the given condition in the third scenario, the identified anomaly 1736 may be tips burning off, or more burners being on than expected in the given calculations to determine the predicted values. The anomaly solution database 1738 may indicate to implement the following prioritized actions for tips being burnt off: replace fuel gas tips. The anomaly solution database 1738 may indicate to implement the following action for more burners being on than expected: validate number of burners that are firing.

Other examples of operation of the prediction engine 1730 include the following. A variation in a fuel-side calculation may indicate that the calculated heat release based on pressure with clean burner tips is higher than a given fuel mass flow measurement. In such situation, the fuel analyzer 1148 may implement the following troubleshooting: (i) identify that one or more of the burners are out of service, (ii) determine if one or more of the fuel valves are full-open (even though they are supposed to be at a specific setting), (iii) determine if the burner tips have additional fouling that is visually identifiable, (iv) determine if the burner tips have a different orifice diameter than expected, and (v) determine if the pressure transmitter or flow meter providing the measurements are in need of calibration.

As another example, a variation in a fuel-side calculation may indicate that the calculated heat release based on pressure with clean burner tips is lower than a given mass flow measurement. In such situation, the fuel analyzer 1148 may implement the following troubleshooting: (i) confirm quantity of out-of-service burners, (ii) verify that the out-of-service burners are truly out of service, (iii) determine if there are gas leaks within the combustion system (visually observed by small “candle flames” until the tip is plugged), (iv) determine if flame patterns match conditions indicating missing burner tips or burner tips that have ports that are eroded, (v) confirm burner tip orifice diameter, (vi) determine improper line loss calculations, (vii) determine if the pressure transmitter or flow meter providing the measurements are in need of calibration.

As another example, a variation in an air-side calculation may indicate that the calculated oxygen is higher than a measured oxygen level. In such situation, the air-side analyzer 1150 (or the emissions analyzer 1154) may implement the following troubleshooting process: (i) confirm the number of burners out-of-service, (ii) confirm that the air register settings are accurate within the model, (iii) analyze the burners for blocked air passages, such as blocked air inlets, refractory fallen into burner throats, wall burner air-tip fouling, loos burner insulation, flashback or combustion back pressure within the burner, (iv) determine potential leaks within the process tubes (and shut down if so), (v) verify ambient air conditions, (vi) check wind speeds, (vii) calibrate air-side measurement devices such as the air-pressure and O2 analyzer.

As another example, a variation in an air-side calculation may indicate that the calculated oxygen is lower than a measured oxygen level. In such situation, the air-side analyzer 1150 (or the emissions analyzer 1154) may implement the following troubleshooting process: (i) confirm the number of burners out-of-service, (ii) confirm that the air register settings are accurate within the model, (iii) analyze for tramp-air entering the system (such as via sight ports, lighting ports, gas tip riser mounting plates, etc.), (iv) determine potential leaks within the process tubes (and shut down if so), (v) verify ambient air conditions, (vi) check wind speeds, (vii) analyze for additional gas leakage into the system, (viii) calibrate air-side measurement devices such as the air-pressure and O2 analyzer.

### Cloud Computing Embodiments:

In embodiments, a portion or all of the combustion system analyzer 1700 may be implemented remotely from the process controller 128, such as in the network-based “cloud”, where the combustion system analyzer and the process controller 128 are a portion of an edge computing scheme. For example, the combustion system analyzer 1700 may be stored and executed at the external server 164, such that after generation of data (e.g., the prediction confidence region 1726, or the control signal 1740), said generated data then transmitted from the external server 164 to the process controller 128 for display on the display 1108 thereof or used automatic control of the hardware associated the system 100. The data in the data historian 1705 may be gathered at the process controller 128 (such as at the system DCS or PLC (plant control system) and transmitted to the external server 164 for analysis by the combustion system analyzer 1700 located on the external server 164. Alternatively, or additionally, one or more of the devices capturing the data stored in the data historian 1705 may be an embedded device having data transmission capability that transfers its respective data directly to the external server 164 for analysis by the combustion system analyzer 1700.

### System Component Validation:

Continued understanding on the modeling side (by any of the above combustion system analyzer 1700, or other physics-based modeling, or analytics discussed herein or in any of the provisional applications incorporated by reference as discussed above) allows for the process controller 128 to monitor and validate the measurement devices that populate the data historian 1705. Because the modeling provides optimized control settings, the analyzers discussed herein are able to compare the measured data to the expected data generated via calculations. If the measured data varies with respect to the calculated data, the system is able to troubleshoot the particular reason for that discrepancy.

### Definitions

The disclosure herein may reference “physics-based models,” “first principles” and transforming, interpolating, or otherwise calculating certain data from other data inputs. Those of ordinary skill in the art should understand what physics-based models incorporate, and the calculations necessary to implement said transforming, interpolating, or otherwise calculating for a given situation. However, the present disclosure incorporates by reference chapter 9 of the “John Zink Hamworthy Combustion Handbook”, which is incorporated by reference in its entirety (Baukal, Charles E. The John Zink Hamworthy Combustion Handbook. Fundamentals. 2nd ed., vol. 1 of 3, CRC Press, 2013) for further disclosure related to understanding of fluid dynamics physics-based modeling and other calculations. It should be appreciated, however, that “physics-based models” and transforming, interpolating, or otherwise calculating certain data from other data inputs is not limited to just those fluid dynamics calculations listed in chapter 9 of the John Zink Hamworthy Combustion Handbook.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween. Examples of combination of features are as follows:

### Combination of Features:

The above described features may be combined in any manner without departing from the scope hereof. The below combination of features includes examples of such combinations, where any feature described above may also be combined with any embodiment of the aspects described below.

(A1) In a first aspect, a system for analyzing combustion system operation, includes a data historian storing measured process data sensed by a plurality of sensors within a heater of the combustion system; a processor; and, memory storing a prediction engine as computer readable instructions that, when executed by the processor, cause the processor to: predict an operating parameter based on at least a portion of the measured process data, determine a hardware uncertainty value based on uncertainty associated with one or more of the plurality of sensors corresponding to the variables of the measured process data used to predict the operating parameter, determine a historical uncertainty defining drift of the variables of the measured process data used to predict the operating parameter as compared to historical distribution of the values of the variables, determine a prediction confidence region using the predicted operating parameter, the hardware uncertainty, and the historical uncertainty, and output a control for the combustion system using the prediction confidence region.

(A2) In an embodiment of (A1), the measured process data including time-series data.

(A3) In any embodiment of (A1)-(A2), the measured process data including one or more of fuel data, air data, heater data, emissions data, and process-side data.

(A4) In any embodiment of (A1)-(A3), the determine the predicted operating parameter including apply first-principal physics calculations using the variables of the measured process data.

(A5) In any embodiment of (A1)-(A4), the hardware uncertainty being a fixed value for each set of the variables used to predict the operating parameter as compared to historical distribution of the values.

(A6) In any embodiment of (A1)-(A5), the hardware uncertainty being determined for the predicted operating parameter Y, that is based on a plurality of variables x₁, x₂, x₃, . . . , x_{N} is

$${ω}_{Y} = \sqrt{{Σ}_{i = 1}^{N} {( {ω}_{{x}_{i}} \frac{\partial f}{\partial {x}_{i}} )}^{2}} .$$

(A7) In any embodiment of (A1)-(A6), the historical uncertainty being a value between 0 and 100 percent.

(A8) In any embodiment of (A1)-(A7), the determine the historical uncertainty including model the statistical deviation of each of the variables used to predict the operating parameter.

(A9) In any embodiment of (A1)-(A8), the model the statistical deviation including determine a Gaussian Mixture Model for the variables used to predict the operating parameter.

(A10) In any embodiment of (A1)-(A9), the determine a prediction confidence region including calculate the prediction confidence region as P±\sqrt{U_{HW}²+U_{Hist}²}; where P is the value of the predicted operating parameter; U_{HW} is the value of the hardware uncertainty; and U_{Hist} is the value of the historical uncertainty.

(A11) In any embodiment of (A1)-(A10), the determine a prediction confidence region including calculate the prediction confidence region as P±(U_{HW}+U_{Hist}); where P is the value of the predicted operating parameter; U_{HW} is the value of the hardware uncertainty; and U_{Hist} is the value of the historical uncertainty.

(A12) In any embodiment of (A1)-(A11), the output the control for the combustion system including compare the prediction confidence region against one or more thresholds to determine breach thereof, and select the control to remedy the breach.

(A13) In any embodiment of (A1)-(A2), the output a control including: identify an anomaly using the predicted confidence region; compare the anomaly to an anomaly solution database; and, output the control as a list of one or more solutions from the anomaly solution database.

(A14) In any embodiment of (A1)-(A12), including any feature described below with respect to the second, third, and fourth aspects, and embodiments thereof.

(B1) In a second aspect, a method for analyzing combustion system operation, includes: predicting an operating parameter based on at least a portion of measured process data sensed by a plurality of sensors within a heater of the combustion system; determining a hardware uncertainty value based on uncertainty associated with one or more of the plurality of sensors corresponding to the variables of the measured process data used to predict the operating parameter, determining a historical uncertainty defining drift of the variables of the measured process data used to predict the operating parameter as compared to historical distribution of the values of the variables, determining a prediction confidence region using the predicted operating parameter, the hardware uncertainty, and the historical uncertainty, and outputting a control for the combustion system using the prediction confidence region.

(B2) In an embodiment of (B1), the measured process data including time-series data.

(B3) In any embodiment of (B1)-(B2), the measured process data including one or more of fuel data, air data, heater data, emissions data, and process-side data.

(B4) In any embodiment of (B1)-(B3), the determining the predicted operating parameter including applying first-principal physics calculations using the variables of the measured process data.

(B5) In any embodiment of (B1)-(B4), the hardware uncertainty being a fixed value for each set of the variables used to predict the operating parameter as compared to historical distribution of the values.

(B6) In any embodiment of (B1)-(B5), the hardware uncertainty being determined for the predicted operating parameter Y, that is based on a plurality of variables x₁, x₂, x₃, . . . , x_{N} is

$${ω}_{Y} = \sqrt{{Σ}_{i = 1}^{N} {( {ω}_{{x}_{i}} \frac{\partial f}{\partial {x}_{i}} )}^{2}} .$$

(B7) In any embodiment of (B1)-(B6), the historical uncertainty being a value between 0 and 100 percent.

(B8) In any embodiment of (B1)-(B7), the determining the historical uncertainty including modeling the statistical deviation of each of the variables used to predict the operating parameter.

(B9) In any embodiment of (B1)-(B8), the modeling the statistical deviation including determine a Gaussian Mixture Model for the variables used to predict the operating parameter.

(B10) In any embodiment of (B1)-(B9), the determining a prediction confidence region including calculating the prediction confidence region as P±\sqrt{U_{HW}²+U_{Hist}²}; where P is the value of the predicted operating parameter; U_{HW} is the value of the hardware uncertainty; and U_{Hist} is the value of the historical uncertainty.

(B11) In any embodiment of (B1)-(B10), the determine a prediction confidence region including calculating the prediction confidence region as P±(U_{H}W+U_{Hist}); where P is the value of the predicted operating parameter; U_{H}W is the value of the hardware uncertainty; and U_{Hist} is the value of the historical uncertainty.

(B12) In any embodiment of (B1)-(B11), the outputting the control for the combustion system including comparing the prediction confidence region against one or more thresholds to determine breach thereof, and select the control to remedy the breach.

(B13) In any embodiment of (B1)-(B12), the outputting a control including: identifying an anomaly using the predicted confidence region; comparing the anomaly to an anomaly solution database; and, outputting the control as a list of one or more solutions from the anomaly solution database.

(B14) In any embodiment of (B1)-(B12), including any feature described with respect to the first aspect, above, and the third and fourth aspects, below, and embodiments thereof.

(C1) In a third aspect, a system for analyzing combustion system operation, includes: a data historian storing measured process data sensed by a plurality of sensors within a heater of the combustion system; a processor; and, memory storing a recommendation engine as computer readable instructions that, when executed by the processor, cause the processor to: compare a measured operating parameter condition against a predicted operating parameter condition to identify an anomaly; compare the identified anomaly against an anomaly solution database; output a control signal including one or more solutions from the anomaly solution database.

(C2) In an embodiment of (C1), the compare a measured operating parameter condition against a predicted operating parameter condition including: compare a first measured operating parameter against a first predicted operating parameter; and compare a second measured operating parameter against at least two second predicted operating parameters.

(C3) In any embodiment of (C1)-(C2), further comprising computer readable instructions that, when executed by the processor, cause the processor to further calculate the predicted operating parameter including a prediction confidence region, the predicted confidence region being based on a predicted operating parameter value, a hardware uncertainty value, and a historical uncertainty value.

(C4) In any embodiment of (C1)-(C2), further comprising computer readable instructions that, when executed by the processor, cause the processor to further prioritize the one or more solutions from the anomaly database.

(C5) In any embodiment of (C4), the prioritize including prioritize based on one or more of cost-to-implement, fastest-to-implement, ease-to-implement, and past success rate.

(C6) In any embodiment of (C1)-(C5), the control signal including one or more of automatically control of a component of the combustion system, automatic shutdown of the combustion system when the anomaly indicates a safety breach, and a display control to a display of the combustion system.

(C7) In any embodiment of (C1)-(C6), further comprising computer readable instructions that, when executed by the processor, cause the processor to receive feedback regarding the output control signal.

(C8) In any embodiment of (C7), further comprising computer readable instructions that, when executed by the processor, cause the processor to update the anomaly solutions database based on the feedback.

(C9) In any embodiment of (C7)-(C8), the feedback being based on implementation of a solution in the anomaly solutions database at different combustion system.

(C10) In any embodiment of (C1)-(C9), including any feature described with respect to the first and second aspects, above, and the fourth aspect, below, and embodiments thereof.

(D1) In a fourth aspect a method for analyzing combustion system operation, includes: comparing a measured operating parameter condition against a predicted operating parameter condition to identify an anomaly; comparing the identified anomaly against an anomaly solution database; outputting a control signal including one or more solutions from the anomaly solution database.

(D2) In an embodiment of (D1), the compare a measured operating parameter condition against a predicted operating parameter condition including: comparing a first measured operating parameter against a first predicted operating parameter; and comparing a second measured operating parameter against at least two second predicted operating parameters.

(D3) In any embodiment of (D1)-(D2), further comprising calculating the predicted operating parameter including a prediction confidence region, the predicted confidence region being based on a predicted operating parameter value, a hardware uncertainty value, and a historical uncertainty value.

(D4) In any embodiment of (D1)-(D3), further comprising prioritizing the one or more solutions from the anomaly database.

(D5) In any embodiment of (D4), the prioritizing including prioritizing based on one or more of cost-to-implement, fastest-to-implement, ease-to-implement, and past success rate.

(D6) In any embodiment of (D1)-(D5), the control signal including one or more of automatically control of a component of the combustion system, automatic shutdown of the combustion system when the anomaly indicates a safety breach, and a display control to a display of the combustion system.

(D7) In any embodiment of (D1)-(D6), further comprising receiving feedback regarding the output control signal.

(D8) In any embodiment of (D7), further comprising updating the anomaly solutions database based on the feedback.

(D9) In any embodiment of (D7)-(D8), the feedback being based on implementation of a solution in the anomaly solutions database at different combustion system.

(D10) In any embodiment of (D1)-(D9), including any feature described with respect to the first, second, and third aspects, above, and embodiments thereof.

1. A system for analyzing combustion system operation, comprising:
a data historian storing measured process data sensed by a plurality of sensors within a heater of the combustion system;
a processor; and,
non-transitory memory storing a prediction engine as computer readable instructions that, when executed by the processor, cause the processor to:
predict an operating parameter based on at least a portion of the measured process data,
determine a hardware uncertainty value based on uncertainty associated with one or more of the plurality of sensors corresponding to variables of the measured process data used to predict the operating parameter,
determine a historical uncertainty defining drift of the variables of the measured process data used to predict the operating parameter as compared to historical distribution of the values of the variables,
determine a prediction confidence region using the predicted operating parameter, the hardware uncertainty value, and the historical uncertainty, and
output a control for the combustion system using the prediction confidence region.

2. The system of claim 1, the measured process data including time-series data.

3. The system of claim 1, the measured process data including one or more of fuel data, air data, heater data, emissions data, and process-side data.

4. The system of claim 1, the determine the predicted operating parameter including apply first-principal physics calculations using the variables of the measured process data.

5. The system of claim 1, the hardware uncertainty being a fixed value for each set of the variables used to predict the operating parameter as compared to historical distribution of the values.

6. The system of claim 1, the hardware uncertainty being determined for the predicted operating parameter Y, that is based on the variables, wherein the variables are x₁, x₂, x₃, . . . , x_{N} and is
$${ω}_{Y} = \sqrt{{Σ}_{i = 1}^{N} {( {ω}_{{x}_{i}} \frac{\partial f}{\partial {x}_{i}} )}^{2}} .$$

7. The system of claim 1, the historical uncertainty being a value between 0 and 100 percent.

8. The system of claim 1, the determine the historical uncertainty comprises modeling a statistical deviation of each of the variables used to predict the operating parameter.

9. The system of claim 8, the modeling of the statistical deviation comprises determining a Gaussian Mixture Model for the variables used to predict the operating parameter.

10. The system of claim 1, the determine a prediction confidence region including calculate the prediction confidence region as P±\sqrt{U_{HW}²+U_{Hist}²}; where P is the value of the predicted operating parameter; U_{HW} is the value of the hardware uncertainty; and U_{Hist} is the value of the historical uncertainty.

11. The system of claim 1, the determine a prediction confidence region including calculate the prediction confidence region as P±(U_{HW}+U_{Hist}); where P is the value of the predicted operating parameter; U_{HW} is the value of the hardware uncertainty; and U_{Hist} is the value of the historical uncertainty.

12. The system of claim 1, the output the control for the combustion system including compare the prediction confidence region against one or more thresholds to determine breach thereof, and select the control to remedy the breach.

13. The system of claim 1, the output a control including:
identify an anomaly using the predicted confidence region;
compare the anomaly to an anomaly solution database; and,
output the control as a list of one or more solutions from the anomaly solution database.

14. A method for analyzing combustion system operation, comprising:
predicting an operating parameter based on at least a portion of measured process data sensed by a plurality of sensors within a heater of the combustion system;
determining a hardware uncertainty value based on uncertainty associated with one or more of the plurality of sensors corresponding to variables of the measured process data used to predict the operating parameter,
determining a historical uncertainty defining drift of the variables of the measured process data used to predict the operating parameter as compared to historical distribution of the values of the variables,
determining a prediction confidence region using the predicted operating parameter, the hardware uncertainty, and the historical uncertainty, and
outputting a control for the combustion system using the prediction confidence region.

15. The method of claim 14, the measured process data including time-series data.

16. The method of claim 14, the measured process data including one or more of fuel data, air data, heater data, emissions data, and process-side data.

17. The method of claim 14, the determining the predicted operating parameter including applying first-principal physics calculations using the variables of the measured process data.

18. The method of claim 14, the hardware uncertainty being a fixed value for each set of the variables used to predict the operating parameter as compared to historical distribution of the values.

19. The method of claim 14, the hardware uncertainty being determined for the predicted operating parameter Y, that is based on a plurality of variables x₁, x₂, x₃, . . . , x_{N} is
$${ω}_{Y} = \sqrt{{Σ}_{i = 1}^{N} {( {ω}_{{x}_{i}} \frac{\partial f}{\partial {x}_{i}} )}^{2}} .$$

20. The method of claim 14, the historical uncertainty being a value between 0 and 100 percent.

21. The method of claim 14, the determining the historical uncertainty comprises modeling a statistical deviation of each of the variables used to predict the operating parameter.

22. The method of claim 21, the modeling the statistical deviation including determine a Gaussian Mixture Model for the variables used to predict the operating parameter.

23. The method of claim 14, the determining a prediction confidence region including calculating the prediction confidence region as P±\sqrt{U_{HW}²+U_{Hist}²}; where P is the value of the predicted operating parameter; U_{HW} is the value of the hardware uncertainty; and U_{Hist} is the value of the historical uncertainty.

24. The method of claim 14, the determine a prediction confidence region including calculating the prediction confidence region as P±(U_{HW}+U_{Hist}); where P is the value of the predicted operating parameter; U_{HW} is the value of the hardware uncertainty; and U_{Hist} is the value of the historical uncertainty.

25. The method of claim 14, the outputting the control for the combustion system including comparing the prediction confidence region against one or more thresholds to determine breach thereof, and select the control to remedy the breach.

26. The method of claim 14, the outputting a control including:
identifying an anomaly using the predicted confidence region;
comparing the anomaly to an anomaly solution database; and,
outputting the control as a list of one or more solutions from the anomaly solution database.

27. A system for analyzing combustion system operation, comprising:
a data historian storing measured process data sensed by a plurality of sensors within a heater of the combustion system;
a processor; and,
non-transitory memory storing a recommendation engine as computer readable instructions that, when executed by the processor, cause the processor to:
identify a measured operating parameter condition from the process data sensed by the plurality of sensors;
compare the measured operating parameter condition against a predicted operating parameter condition using a prediction confidence region to identify an anomaly, the prediction confidence region being determined using a hardware uncertainty associated with at least one of the sensors and a historical uncertainty determined in association with the predicted operating parameter condition;
compare the identified anomaly against an anomaly solution database; and
output a control signal including one or more solutions from the anomaly solution database.

28. The system of claim 27, the compare a measured operating parameter condition against a predicted operating parameter condition including:
compare a first measured operating parameter against a first predicted operating parameter; and
compare a second measured operating parameter against at least two second predicted operating parameters.

29. The system of claim 27, further comprising computer readable instructions that, when executed by the processor, cause the processor to further calculate the predicted operating parameter including a prediction confidence region, the predicted confidence region being based on a predicted operating parameter value, a hardware uncertainty value, and a historical uncertainty value.

30. The system of claim 27, further comprising computer readable instructions that, when executed by the processor, cause the processor to further prioritize the one or more solutions from the anomaly database.

31. The system of claim 30, the prioritize including prioritize based on one or more of cost-to-implement, fastest-to-implement, ease-to-implement, and past success rate.

32. The system of claim 27, the control signal including one or more of automatic control of a component of the combustion system, automatic shutdown of the combustion system when the anomaly indicates a safety breach, and a display control to a display of the combustion system.

33. The system of claim 27, further comprising computer readable instructions that, when executed by the processor, cause the processor to receive feedback regarding the control signal as outputted.

34. The system of claim 33, further comprising computer readable instructions that, when executed by the processor, cause the processor to update the anomaly solutions database based on the feedback.

35. The system of claim 33, the feedback being based on implementation of a solution in the anomaly solutions database at different combustion system.

36. A method for analyzing combustion system operation, comprising:
identifying a measured operating parameter condition from process data sensed by a plurality of sensors;
comparing the measured operating parameter condition against a predicted operating parameter condition using a prediction confidence region to identify an anomaly, the prediction confidence region being determined using a hardware uncertainty associated with at least one of the sensors and a historical uncertainty determined in association with the predicted operating parameter condition;
comparing the identified anomaly against an anomaly solution database; and
outputting a control signal including one or more solutions from the anomaly solution database.

37. The method of claim 36, the compare a measured operating parameter condition against a predicted operating parameter condition including:
comparing a first measured operating parameter against a first predicted operating parameter; and
comparing a second measured operating parameter against at least two second predicted operating parameters.

38. The method of claim 36, further comprising calculating the predicted operating parameter including a prediction confidence region, the predicted confidence region being based on a predicted operating parameter value, a hardware uncertainty value, and a historical uncertainty value.

39. The method of claim 36, further comprising prioritizing one of the solutions from the anomaly database as compared to other ones of the solutions.

40. The method of claim 39, the prioritizing including prioritizing based on one or more of cost-to-implement, fastest-to-implement, ease-to-implement, and past success rate.

41. The method of claim 36, the control signal including one or more of automatic control of a component of the combustion system, automatic shutdown of the combustion system when the anomaly indicates a safety breach, and a display control to a display of the combustion system.

42. The method of claim 36, further comprising receiving feedback regarding the output control signal.

43. The method of claim 42, further comprising updating the anomaly solutions database based on the feedback.

44. The method of claim 42, the feedback being based on implementation of a solution in the anomaly solutions database at different combustion system.
